(19) United States
(12) Patent Application Publication
(10) Pub. No.: US 2026/0310429 A1
(43) Pub. Date: Oct. 8, 2026

(54) SOFTWARE SYSTEMS AND METHODS FOR ADVANCED OUTPUT-AFFECTING LINEAR PATHWAY (A-OALP) CROSS-COMMUNICATION

(71) Applicant: Kevin D. HOWARD, Mesa, AZ (US)

(72) Inventor: Kevin D. HOWARD, Mesa, AZ (US)

(21) Appl. No.: 19/406,695

(22) Filed: Dec. 2, 2025

Related U.S. Application Data
(63) Continuation-in-part of application No. 19/301,590, filed on Aug. 15, 2025, now Pat. No. 12,625,689.
Application No. 19/301,590 is a continuation of application No. 19/171,172, filed on Apr. 4, 2025, now Pat. No. 12,411,671.

(51) Int. Cl. G06F 8/41

(52) U.S. Cl. CPC G06F 8/443

(57) ABSTRACT

Systems and methods are provided for enabling lockless cross-communication of Advanced Output-Affecting Linear Pathways (A-OALPs) across multiple processing elements in a single server environment. Processing time and memory allocation are predicted using advanced time and space complexity, and applying oversubscription of data and temporal reordering to resolve sequence order without software locks. Such techniques reduce cross-communication overhead in both task and non-task parallelization, including one-, two-, and three-dimensional array exchanges. Data structures such as linear, circular, cylindrical, and toroidal arrays are automatically analyzed to determine oversubscription layouts, with higher-dimensional cylindrical and toroidal exchanges enabling detection of adjacency relationships that can exploit quantum superposition. These approaches provide a unified model for efficient lockless communication, improved workload balancing, and automatic determination of when quantum or classical execution is advantageous.

### CROSS-REFERENCE TO RELATED APPLICATIONS

This Application is a continuation-in-part of U.S. patent application Ser. No. 19/301,590, filed Aug. 15, 2025, which is a continuation of U.S. patent application Ser. No. 19/171,172, filed Apr. 4, 2025 and now issued as U.S. Pat. No. 12,411,671; with each of the referenced applications and disclosures fully incorporated herein by reference.

### TECHNICAL FIELD

The present invention relates generally to using single server, multi-core, multi-instance, parallel cross-communication without the use of software locks, and to determining when a data exchange can advantageously execute using quantum versus classical communication techniques.

### BACKGROUND OF THE INVENTION

The general definition of an algorithm is any sequence of operations that can be simulated by a Turing-complete system, meaning that software applications are also algorithms. Consider that an algorithm can contain multiple sequences of operations combined using conditional statements. Each of these separate sequences of operations is considered an execution pathway through the software algorithm. As a general rule, each pathway consists of a different sequence of operations. The exceptions to this general rule are looping structures, which consist of a repeating set of the same sequence of operations. Because looping structures do not represent different sequences of operations, they are instead considered as part of the same execution pathway even though loops always contain conditional statements in their definitions.

Cross-communication means data that is transferred from one processing element (core) to another in the normal course of an algorithm processing an input dataset. This can occur when data is transferred from one instance to another, which happens in non-task parallel processing, or from one task to another in the case of task parallelism. In both cases the transferred data might require sequence order protection. There are three circumstances requiring the data to have sequence order protection: when the data has not yet been created, when the required data has been overwritten prior to its use, and when the data has not completed updating.

Modern computer systems are multi-threaded, meaning that it is possible for one thread to be required to wait for some code block on another thread to complete prior to its continuation, an example of the first sequence order protection circumstance. This is especially true for parallel or concurrently executing software codes. Without accurate processing time prediction, it is difficult for a software system to know when data might have aged to the point of not being usable, an example of the second sequence order protection circumstance. In addition, not knowing the processing time means that data might have been deleted, the third sequence order protection circumstance. Because it is not possible for known systems to reliably predict the processing times of various code blocks or of tasks and processes in interacting tasks or software instances, software locks (sometimes called Mutual Exclusions (MUTEXs)) are traditionally used to provide the needed protection. Unfortunately, software locks are not always efficient, and in some cases, they can eliminate some or all of the performance gains from the parallelization of software codes. The locks themselves can be a source of sequence order problems, as in the so-called “deadlock” conditions.

Any software structure that can reliably generate a time prediction for that structure could eliminate the need for the majority of locks, especially for shared memory machines like multicore systems. U.S. Pat. No. 11,520,560, Computer Processing and Outcome Prediction Systems and Methods and U.S. Pat. No. 12,411,671, Software Systems and Methods for Advanced Output-Affecting Linear Pathways, have demonstrated two software structures for which processing time and memory allocation can be reliably predicted, time affecting linear pathways (TALPs) and advanced output affecting linear pathways (A-OALPs). Advanced time complexity and advanced space complexity are used herein to predict processing time and memory allocation. Combining reliable processing time prediction with various types of data oversubscription (duplication of data used between processing elements to ensure that shared data is stable) shown herein can eliminate the vast majority of lock requirements.

TALPs and A-OALPs both differentiate between static (non-variable time) and variable time looping structures. With static time looping structures, the loop indexes remain unrelated to either direct or indirect use of an input variable attribute. Variable time looping structures have their loop indexes tied to at least one input variable attribute and are parallelization methods (dynamic loop unrolling, which breaks up index variable values into discrete ranges, discretization) that show that cross-communication is limited to those variables.

Although the concept of oversubscription is generally understood, there is no general model for when to apply it successfully to remove sequence order problems, and so it is considered much more difficult to use than MUTEXs are. Oversubscription and/or time prediction with temporal reordering (changing the order of the data exchange time steps) can be used to automatically remove sequence order issues in shared memory environments as shown herein. This automatic method of sequence order resolution is easier to use than the manually inserted MUTEX methods.

Known discussions on communication do not show the relationship between classical communication and communication that could take advantage of quantum effects like superposition. To take advantage of inherently quantum effects, and to automatically be able to use the best hardware, requires determining this relationship as shown herein.

### SUMMARY OF THE INVENTION

Oversubscription and/or time prediction with temporal reordering are automatically used herein to eliminate the need for locks for sequence order resolution of single server, multi-core, multi-instance parallel cross-communication. The present invention discusses cross-communication (data exchange across cores) methods that use oversubscription within temporal looping structures for processing 1-dimensional, 2-dimensional, and 3-dimensional arrays. Unlike traditional uses of oversubscription, which either have the programmer determine where oversubscription should go or use specialized functions that already perform oversubscription for certain data movements, the present technology automatically uses the dimensionality of the variable(s) within temporal looping structures involved in data exchanges to generate a unique lockless cross-communication. This model thus ties together processing time and oversubscription.

For non-task parallelization, the concepts of linear, circular, cylindrical, and toroidal data structures are explored as underlying rules for various data exchanges including left, right, up, down, outer, inner, checkerboard, next-n-neighbor, and all-to-all exchanges. The techniques herein are those that automatically use oversubscription of data and/or temporal reordering to eliminate the need for most locking structures, greatly decreasing the cross-communication overhead cost.

A relationship is found between 3-dimensional (and higher) data exchanges on cylindrical and toroidal data structures and superposition adjacency between variables. This relationship allows for the automatic determination of codes that can take advantage of inherent quantum effects. Various superposition-based data exchanges are shown.

For task parallelization, the ability to accurately predict processing time given some input dataset is used to ensure that a data-producing task completes prior to its use by at least one data-consuming task of the same data.

In various embodiments, a method to determine oversubscription data layouts for Advanced Output-Affecting Linear Pathways (A-OALPs) executing on multiple Processing Elements (PEs) comprises determining oversubscribed data elements needed for lockless cross-communication, and determining sequence order resolution for a single server, multiple PEs, and multi-instance parallel cross-communication.

### BRIEF DESCRIPTION OF THE DRAWINGS

The accompanying drawings, which are incorporated herein and form part of the specification, illustrate various embodiments of the present disclosure and, together with the description, further explain the principles of the disclosure and enable a person skilled in the pertinent art to make and use the embodiments disclosed herein. In the drawings, like reference numbers indicate identical or functionally similar elements.

FIG. 1 shows a diagram of an example 1-dimensional non-exchange and three examples of left and right linear, array element exchanges executing on a single processing element (core), in accordance with embodiments of the present invention.

FIG. 2 is an example showing the equation versus the “C” programming language form of a 1-dimensional, left linear, single element exchange executing on a single core, in accordance with embodiments of the present invention.

FIG. 3 is an example showing the equation versus the “C” programming language form of a 1-dimensional, right linear, single element exchange executing on a single core, in accordance with embodiments of the present invention.

FIG. 4 is an example showing the equation versus the “C” programming language form of a 1-dimensional, left linear, two-element exchange executing on a single core, in accordance with embodiments of the present invention.

FIG. 5 is an example showing the equation versus the “C” programming language form of a 1-dimensional, left linear, four-element exchange executing on a single core, in accordance with embodiments of the present invention.

FIG. 6 is an example showing the equation versus the “C” programming language form of a 1-dimensional, left linear, single element next-neighbor exchange executing on a single core, in accordance with embodiments of the present invention.

FIG. 7 is an example showing the equation versus the “C” programming language form of a 1-dimensional non-exchange, executing on two cores, in accordance with embodiments of the present invention.

FIG. 8 shows a diagram of an example 1-dimensional non-exchange and three examples of left and right linear, one-, two-, and four-element exchanges executing on two cores, in accordance with embodiments of the present invention.

FIG. 9 is an example showing the equation versus the “C” programming language form of a 1-dimensional, left linear, single element exchange executing on two cores, in accordance with embodiments of the present invention.

FIG. 10 is a diagram of an example of incorrect data being exchanged because of multi-core temporal ambiguities in a 1-dimensional, left linear, single element exchange executing on two cores, in accordance with embodiments of the present invention.

FIG. 11 is a diagram of an example 1-dimensional, left linear, single element exchange executing on two cores, using a simple lock/unlock mechanism, without oversubscription or temporal reordering, in accordance with embodiments of the present invention.

FIG. 12 is a diagram of an example 1-dimensional, left linear, single element exchange executing on two cores, using both temporal reordering and a locking method, but no oversubscription, in accordance with embodiments of the present invention.

FIG. 13 is a diagram showing a 1-dimensional, left linear, single element exchanges executing on two cores, using two different oversubscription methods, without temporal reordering, instead of a locking method.

FIG. 14 is an example showing the equation versus the “C” programming language form of a 1-dimensional, left linear, two-element exchange executing on two cores, with an oversubscription method shown in FIG. 13, in accordance with embodiments of the present invention.

FIG. 15 is a diagram of the example 1-dimensional, left linear, two-element exchange executing on two cores, using an oversubscription method, shown in FIG. 14, in accordance with embodiments of the present invention.

FIG. 16 is an example showing the equation versus the “C” programming language form of a 1-dimensional, left linear, single element exchange with a function, executing on two cores, with oversubscription, in accordance with embodiments of the present invention.

FIG. 17 is a diagram of the 1-dimensional, left linear, single element exchange with a calculated function (pre-processed data), executing on two cores, using oversubscription, shown in FIG. 16, in accordance with embodiments of the present invention.

FIG. 18 is an example showing the equation versus the “C” programming language form of a 1-dimensional, left linear, single element exchange with a fixed stride of two, executing on two cores, with oversubscription, in accordance with embodiments of the present invention.

FIG. 19 is a diagram of the 1-dimensional, left linear, single element exchange with a fixed stride of two, executing on two cores, using oversubscription, shown in FIG. 18, in accordance with embodiments of the present invention.

FIG. 20 is a diagram of an example 1-dimensional, left linear, single element exchange with a fixed stride of three, executing on two cores, using oversubscription, in accordance with embodiments of the present invention.

FIG. 21 is an example showing the equation form of an unbalanced workload, 1-dimensional, left linear, single element exchange with variable stride executing on two cores, with oversubscription, in accordance with embodiments of the present invention.

FIG. 22 is a diagram of the unbalanced workload, 1-dimensional, left linear, single element exchange with a variable stride, executing on two cores, using oversubscription, shown in FIG. 21, in accordance with embodiments of the present invention.

FIG. 23 is an example showing the equation form of a rebalanced workload (re-discretized), 1-dimensional, left linear, single element exchange with variable stride executing on two cores, with oversubscription, in accordance with embodiments of the present invention.

FIG. 24 is a diagram of the rebalanced workload, 1-dimensional, left linear, single element exchange with a variable stride, executing on two cores, using oversubscription, shown in FIG. 23, in accordance with embodiments of the present invention.

FIG. 25 is a diagram of another example of an unbalanced workload, 1-dimensional, left linear, single element exchange with a variable stride, executing on two cores, using oversubscription, in accordance with embodiments of the present invention.

FIG. 26 is an example showing the equation versus the “C” programming language form of another rebalanced workload, 1-dimensional, left linear, single element exchange with a variable stride, executing on two cores, with oversubscription, in accordance with embodiments of the present invention.

FIG. 27 is a diagram of the rebalanced workload, 1-dimensional, left linear, single element exchange with a variable stride, executing on two cores, using oversubscription, shown in FIG. 26, in accordance with embodiments of the present invention.

FIG. 28 is an example showing the equation versus the “C” programming language form of a 1-dimensional, left linear, single element all-to-all exchange executing on two cores with an all-element oversubscription, in accordance with embodiments of the present invention.

FIG. 29 is a diagram of a 1-dimensional, left linear, single element all-to-all exchange, executing on two cores, using an all-element oversubscription, shown in FIG. 28, in accordance with embodiments of the present invention.

FIG. 30 is an example showing the equation versus the “C” programming language form of a 1-dimensional, left linear, single element exchange with a two-sided stride, executing on two cores, in accordance with embodiments of the present invention.

FIG. 31 is a diagram of the 1-dimensional, left linear, single element exchange with a two-sided stride, executing on two cores, shown in FIG. 30, in accordance with embodiments of the present invention.

FIG. 32 is a diagram showing two ways to depict a 1-dimensional, left or right circular, single element exchange executing on a single core, showing a circular data structure, in accordance with embodiments of the present invention.

FIG. 33 is an example showing the equation versus the “C” programming language form of a 1-dimensional, left circular, single element exchange executing on two cores, with double oversubscription, in accordance with embodiments of the present invention.

FIG. 34 is a diagram showing the 1-dimensional, left circular, single element exchange executing on two cores, using double oversubscription, shown in FIG. 33, in accordance with embodiments of the present invention.

FIG. 35 is a diagram showing examples of 2-dimensonal, left or right or up or down linear, single column or row exchanges executing on a single core, in accordance with embodiments of the present invention.

FIG. 36 is an example showing the equation versus the “C” programming language form of a 2-dimensional, left linear, single column exchange executing on two cores, with column-based oversubscription, in accordance with embodiments of the present invention.

FIG. 37 is a diagram showing the 2-dimensional, left linear, single column exchange executing on two cores, using column-based oversubscription, shown in FIG. 36, in accordance with embodiments of the present invention.

FIG. 38 is an example showing the equation versus the “C” programming language form of a 2-dimensional, left linear, two-column exchange executing on two cores, with column-based oversubscription, in accordance with embodiments of the present invention.

FIG. 39 is a diagram showing the 2-dimensional, left linear, two-column exchange executing on two cores, using column-based oversubscription, shown in FIG. 38, in accordance with embodiments of the present invention.

FIG. 40 is a diagram showing an example of a 2-dimensional cylindrical data structure, in accordance with embodiments of the present invention.

FIG. 41 is an example showing the equation versus the “C” programming language form of a 2-dimensional, left cylindrical, single column exchange executing on two cores, with column-based double oversubscription, in accordance with embodiments of the present invention.

FIG. 42 is a diagram showing the 2-dimensional, left cylindrical, single column exchange executing on two cores, using column-based double oversubscription, shown in FIG. 41, in accordance with embodiments of the present invention.

FIG. 43 is an example showing the equation versus the “C” programming language form of a 2-dimensional, up linear, single row exchange executing on two cores with row-based oversubscription, in accordance with embodiments of the present invention.

FIG. 44 is a diagram showing the 2-dimensional, up linear, single row exchange executing on two cores, using row-based oversubscription, shown in FIG. 43, in accordance with embodiments of the present invention.

FIG. 45 is an example showing the equation versus the “C” programming language form of a 2-dimensional, up cylindrical, single row exchange, executing on two cores, with row-based double oversubscription, in accordance with embodiments of the present invention.

FIG. 46 is a diagram showing the 2-dimensional, up cylindrical, single row exchange, executing on two cores, using row-based double oversubscription, shown in FIG. 45, in accordance with embodiments of the present invention.

FIG. 47A is a diagram showing a 2-dimensional array executing on two cores using all-element oversubscription, in accordance with embodiments of the present invention.

FIG. 47B is a diagram showing various left/right/up/down exchanges, in accordance with embodiments of the present invention.

FIG. 48 is an example showing the equation versus the “C” programming language form of a 2-dimensional, up left linear, single element checkerboard exchange, executing on two cores, with all-element oversubscription, in accordance with embodiments of the present invention.

FIG. 49 is a diagram showing the 2-dimensional, up left linear, single element checkerboard exchange, executing on two cores, using all-element oversubscription, shown in FIG. 48, in accordance with embodiments of the present invention.

FIG. 50 is an example showing the equation versus the “C” programming language form of a 2-dimensional, up left cylindrical, single element checkerboard exchange, executing on two cores, with all-element oversubscription, in accordance with embodiments of the present invention.

FIG. 51 is a diagram showing the 2-dimensional, up left cylindrical, single element checkerboard exchange, executing on two cores, using all-element oversubscription, shown in FIG. 50, in accordance with embodiments of the present invention.

FIG. 52 is a diagram showing an example of a 2-dimensional toroidal data structure, in accordance with embodiments of the present invention.

FIG. 53 is an example showing the equation versus the “C” programming language form of a 2-dimensional, up left toroidal, single element checkerboard exchange, executing on two cores, with all-element oversubscription, in accordance with embodiments of the present invention.

FIG. 54 is a diagram showing the 2-dimensional, up left toroidal, single element checkerboard exchange, executing on two cores, using all-element oversubscription, shown in FIG. 53, in accordance with embodiments of the present invention.

FIG. 55 is a diagram showing examples of 2-dimensional, linear, single element next-8-neighbor (next-neighbor), next-24-neighbor, and next-63-neighbor exchanges executing on two cores, in accordance with embodiments of the present invention.

FIG. 56 is an example showing the equation versus the “C” programming language form of a 2-dimensional, linear, single element next-neighbor exchange, executing on two cores, with all-element oversubscription, in accordance with embodiments of the present invention.

FIG. 57 is a diagram of the 2-dimensional, linear, single element next-neighbor exchange, executing on two cores, using all-element oversubscription, shown in FIG. 56, in accordance with embodiments of the present invention.

FIG. 58 is an example showing the equation of a 3-dimensional, left/right/up/down/inner/outer linear, single element next-neighbor exchange, executing on two cores, with all-element oversubscription, in accordance with embodiments of the present invention.

FIG. 59 is a diagram showing the 3-dimensional, left/right/up/down/inner/outer linear, single element next-neighbor exchange, executing on two cores, using all-element oversubscription, shown in FIG. 58, in accordance with embodiments of the present invention.

FIGS. 60A-60D show diagrams of four transformations depicting the use of exchanges with unchanged dimensionality or increased dimensionality of the array, in accordance with embodiments of the present invention.

FIG. 61 is a diagram of a 3-dimensional left or right and up or down and inner or outer linear, single element exchange executing on a single core, in accordance with embodiments of the present invention.

FIGS. 62A-62D show diagrams of a 3-dimensional left or right or up or down cylindrical exchange and a superposition-advantaged 3-dimensional left or right and up or down and inner-to-outer or outer-to-inner toroidal exchange, in accordance with embodiments of the present invention.

FIG. 63 is a diagram showing how 3-dimensional cylindrical or toroidal exchanges can be accomplished, each using two possible superposition solutions, in accordance with embodiments of the present invention.

FIG. 64 is a cut-away view of the two possible superposition solutions for 3-dimensional cylindrical or toroidal single element exchanges, in accordance with embodiments of the present invention.

FIGS. 65A-65D show four detailed views (linear adjacency, single element adjacency, circular adjacency, and cylindrical or toroidal adjacency) of two interacting 3-dimensional cylindrical and toroidal, single element exchanges, using superposition, in accordance with embodiments of the present invention.

FIG. 66 is an example of a standard MUTEX lock/unlock system used to manage two tasks that share data, in accordance with embodiments of the present invention.

FIG. 67 is a diagram showing two tasks, a producer and a consumer, each containing an A-OLAP, that share data, where the output of the producer is an input to the consumer, in accordance with embodiments of the present invention.

FIG. 68 is a diagram showing three examples of time used to manage two tasks that share data without a MUTEX or other lock, in accordance with embodiments of the present invention.

FIG. 69 is a diagram showing an always safe periodic data transfer, which requires either locks or oversubscription or temporal reordering, in accordance with embodiments of the present invention.

FIG. 70 is a diagram showing an always unsafe periodic data transfer, which requires either locks or oversubscription or temporal reordering, in accordance with embodiments of the present invention.

### DETAILED DESCRIPTION

Various devices or computing systems can be included and adapted to process and carry out the aspects, computations, and algorithmic processing represented by the software systems and devices of the present invention may include a processor, which may include one or more microprocessors and/or one or more circuits, such as an Application Specific Integrated Circuit (ASIC), Field-Programmable Gate Arrays (FPGAs), Central Processing Units (CPUs), Graphical Processing Units (GPUs), General-Purpose Computing on Graphics Processing Units (GPGPUs), Tensor Processing Units (TPUs), Floating-Point Units (FPUs), single-core, multicore, etc. Further, the devices can include a network interface. The network interface is configured to enable communication with a communication network, other devices and systems, and servers, using a wired and/or wireless and/or quantum connection.

The devices or computing systems may include memory, such as non-transitive, which may include one or more non-volatile storage devices and/or one or more volatile storage devices (e.g., random access memory (RAM) or Qubits. In instances where the computing devices include a microprocessor, computer readable program code may be stored in a computer readable medium or memory, such as, but not limited to drive media (e.g., a hard disk or SSD), optical media (e.g., an OVO), memory devices (e.g., random access memory, flash memory, Qubits), etc. The computer program or software code can be stored on a tangible, or non-transitive, machine-readable medium or memory. In some embodiments, computer readable program code is configured such that when executed by a processor, the code causes the device to perform the steps described above and herein. In other embodiments, the device is configured to perform steps described herein without the need for code.

It will be recognized by one skilled in the art that these operations, algorithms, logic, method steps, routines, subroutines, and modules may be implemented in software, in firmware, in special purpose digital logic, and any combination thereof without deviating from the spirit and scope of the present invention as recited within the claims attached hereto.

The devices or computing devices may include an input device. The input devices are configured to receive an input from either a user (e.g., admin, user, etc.) or a hardware or software component—as disclosed herein in connection with the various user interface or automatic data inputs. Examples of an input device include a keyboard, mouse, microphone, touch screen and software enabling interaction with a touch screen, etc. The devices can also include an output device. Examples of output devices include monitors, televisions, mobile devices screens, tablet screens, speakers, remote screens, etc. The output devices can be configured to display images, media files, text, video or play audio to a user through speaker output.

Server processing systems for use or connected with the systems of the present invention, can include one or more microprocessors, and/or one or more circuits, such as an application specific integrated circuits, such as ASICs, FPGAs, etc. A network interface can be configured to enable communication with a communication network, using a wired and/or wireless connection, including communication with devices or computing devices disclosed herein. Memory can include one or more non-volatile storage devices and/or one or more volatile storage devices (e.g., RAM). In instances where the server system includes a microprocessor, computer readable program code may be stored in a computer readable program code may be stored in a computer readable medium, such as, but not limited to drive media (e.g., a hard disk or SSD), optical media (e.g., a DVD), memory devices, etc.

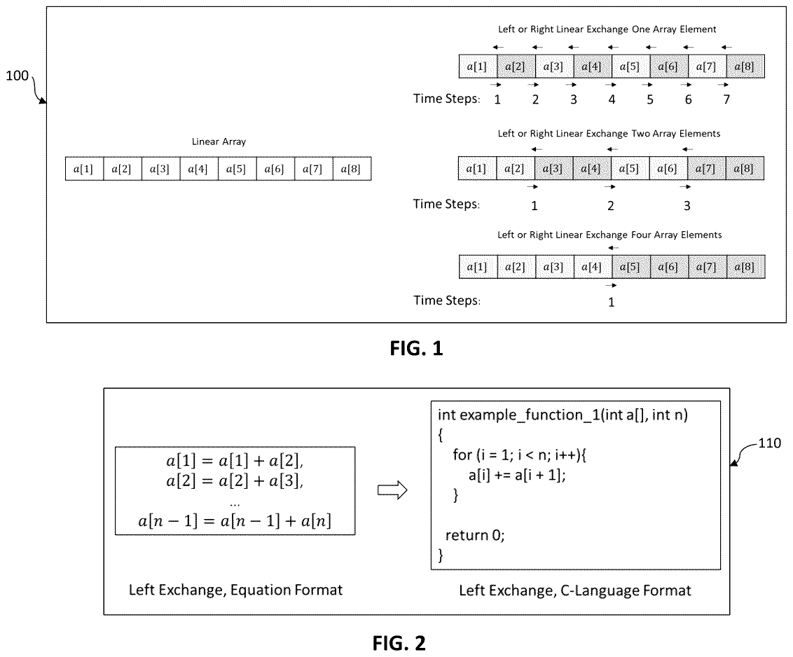

With regard to FIG. 1 through FIG. 59, the elimination of most locks, greatly decreasing the cross-communication overhead cost, is accomplished using various data oversubscription methods and/or temporal reordering techniques, both of which are dependent on parallel processing methods, rather than constructing known specialized communication functions as is performed presently in the industry. Parallel processing methods require the discretization of those input variables (arrays) that are within temporal looping structures and are themselves associated with the loop indexes of those structures. This discretization as well as the oversubscription methods and temporal reordering techniques herein require the use of advanced time complexity and advanced space complexity. The cross-communication for the data exchanges of 1-dimensional, 2-dimensional, and 3-dimensional arrays across multiple processing elements or cores is shown. Note that the use of multiple processing elements or cores in parallel processing implies the use of multiple threads. Where a single processing element or core is used, no cross-communication is shown, only the data movement. It should be noted that the detection of these data exchanges, as well as their underlying data structures in source code, can now be automated.

Throughout the present disclosure, a core can mean a processing element, one or more cores can mean one or more processing elements, and multiple cores can mean multiple processing elements.

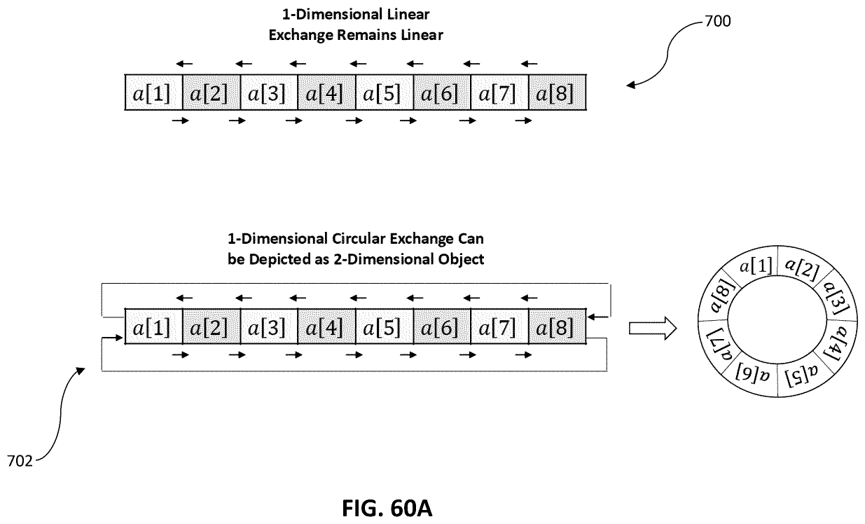

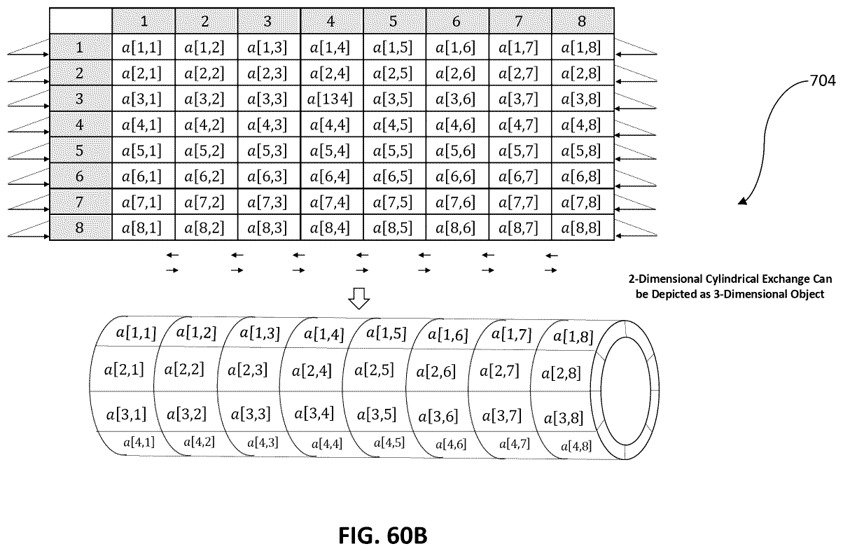

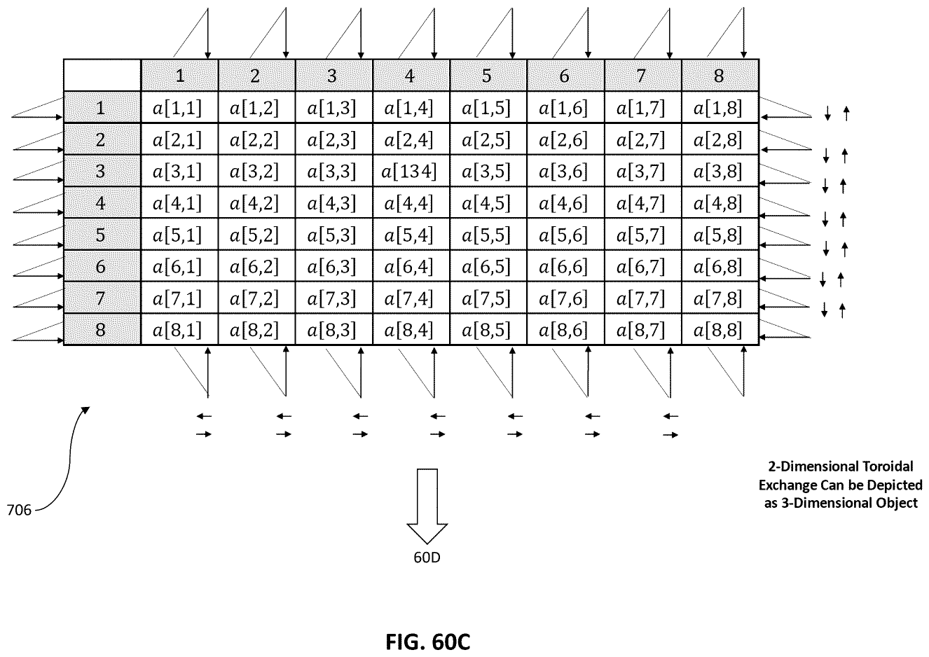

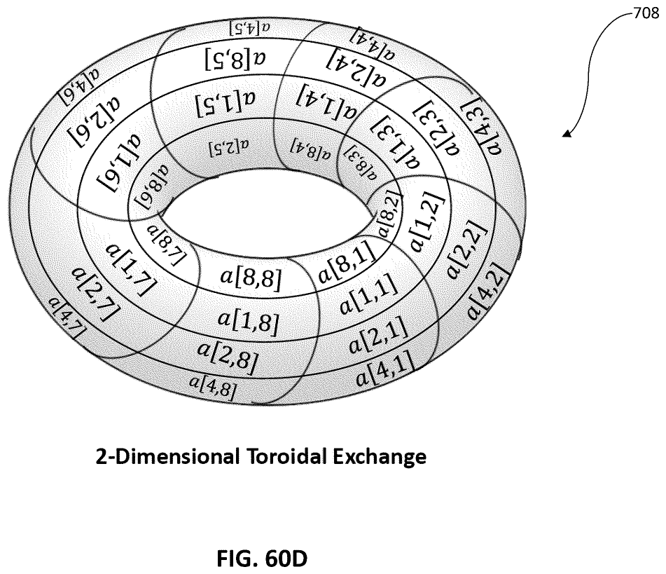

FIG. 60A through FIG. 65D address the relationship found between 3-dimensional (and higher) data exchanges on a cylindrical or toroidal data structure and superposition adjacency between variables in order to control communication timing costs. This relationship allows for the automatic determination of codes that can take advantage of inherent quantum effects. Knowing when and what type of superposition adjacency is possible means that the system can: 1) detect what part of a code can take advantage of quantum circuits and 2) predict the temporal effects of using those quantum circuits.

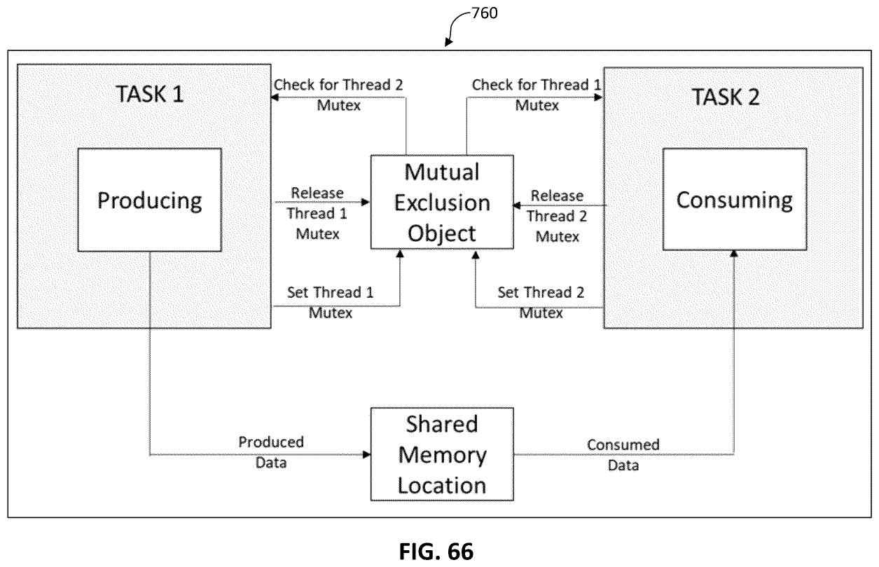

FIG. 66 through FIG. 70 address the use of task processing time prediction to determine when data is produced (generated) and when it is consumed (used) in order to perform temporal reordering to eliminate the use of most locks while providing sequence order protection. Single variable as well as array variable processing time can be adjusted using these methods. It should be noted that Advanced Output-Affecting Linear Pathways (A-OALPs) combine task-like with dynamic loop unrolling parallelization, meaning that the techniques shown for FIG. 66 through FIG. 70 are directly applicable to A-OALPs.

Referring back to FIG. 1, diagram 100 provides an example of a 1-dmensional non-exchange and three examples of left and right linear, array element exchanges executing on a single processing element (e.g., single core). The non-exchange occurs either when there is no processing activity associated with the array or when non-array variables interact with the array. When non-array variables interact then the task-like parallelization techniques shown in FIG. 66 through FIG. 70 can be used even when the activity occurs for the same task. The first data exchange shows the single element movement of data either to the left or to the right in a 1-dimensonal array whereby the first element and last element do not share data. The second data exchange shows the same 1-dimensional array with two-element left or right data sharing. The third shows the 1-dimensional array with four-element left or right data sharing. Since the first and last elements do not communicate, all of the data exchange examples are types of linear exchanges.

With regards to FIG. 2 through FIG. 7, if a 1-dimensional array is oriented to rows then there are four basic 1-dimensional linear exchanges: left exchange, right exchange, next-n-neighbor exchange, and all-to-all exchange. If a 1-dimensional array is oriented to columns then those same four exchanges are called up exchange, down exchange, next-n-neighbor exchange, and all-to-all exchange. Each of the linear exchange types has two kinds of interaction: raw (unprocessed) data and processed (calculated within a function) data. This group of figures only use raw unprocessed data in the exchanges.

FIG. 2 is an example diagram 110 showing the equation versus the “C” programming language form of the 1-dimensional, left linear, single element exchange executing on a single core shown in FIG. 1. The equation form shows a set of equations, indexed from 1 through (n-1). The first array element has the second array element added to it, the second element has the third element added, and so on until the second to last element has the last element added to it. Thus, the left element always has its next right element added to it.

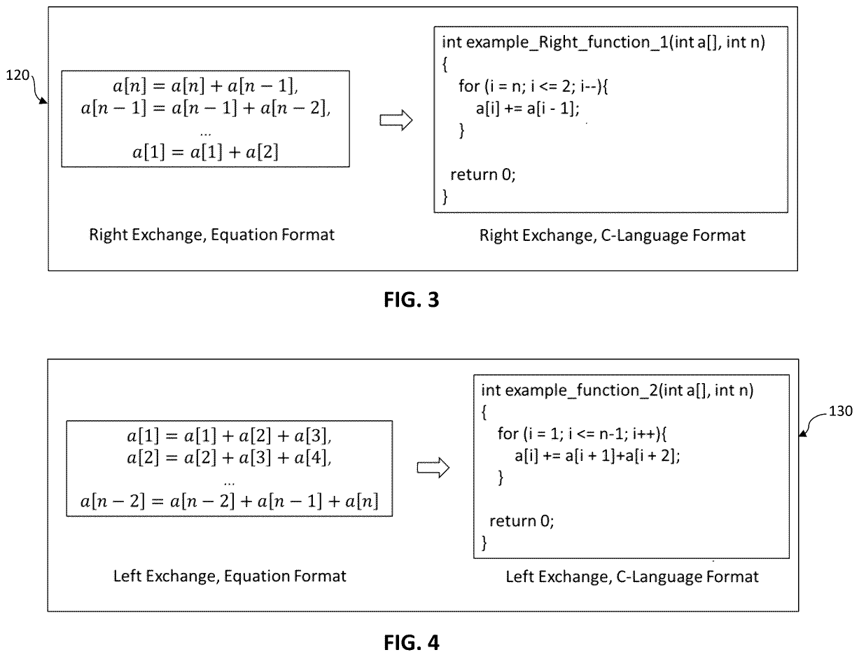

FIG. 3 is an example diagram 120 showing the equation versus the “C” programming language form of the 1-dimensional, right linear, single element exchange executing on a single core shown in FIG. 1. The equation form shows a set of equations, indexed from n through 1. The last array element has the second to last array element added to it, the second to last element has the third to last element added, and so on until the first element has the second element added to it. Thus, the right element always has its next left element added to it.

FIG. 4 is an example diagram 130 showing the equation versus the “C” programming language form of the 1-dimensional, left linear, two element exchange executing on a single core shown in FIG. 1. The equation form shows a set of equations, indexed from 1 through (n-2). The first array element has both the second and third array elements added to it, the second element has both the third and fourth elements added, and so on until the third to last element has the second to last and the last elements added to it. Thus, the left element always has its next two right elements added to it.

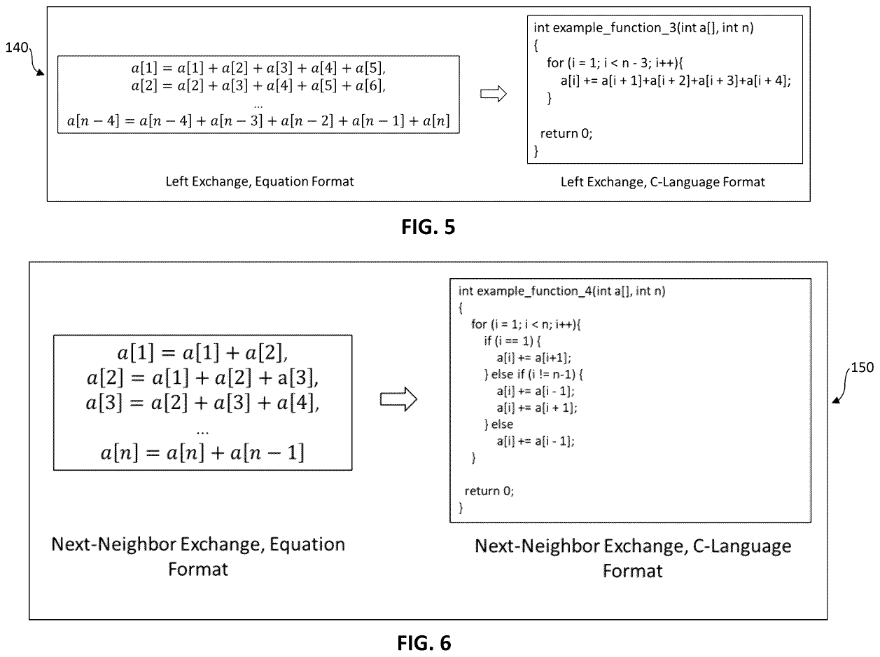

FIG. 5 is an example diagram 140 showing the equation versus the “C” programming language form of the 1-dimensional, left linear, four element exchange executing on a single core shown in FIG. 1. The equation form shows a set of equations, indexed from 1 through (n-4). The first array element has the second, third, fourth, and fifth array elements added to it, the second array element has the third, fourth, fifth, and sixth array elements added to it, and so on until the fourth to last array element has the fifth, sixth, seventh, and eighth to last and the last array elements added to it. Thus, the left element always has its next four right elements added to it.

FIG. 6 is an example diagram 150 showing the equation versus the “C” programming language form of a 1-dimensional, next-8-neighbor (popularly called the next-neighbor) linear, single element exchange executing on a single core. The equation form shows a set of equations, indexed from 1 through n. The first array element has the second array element added to it, the second array element has the first and third array elements added to it, and so on until the last array element has the second to last array element added to it.

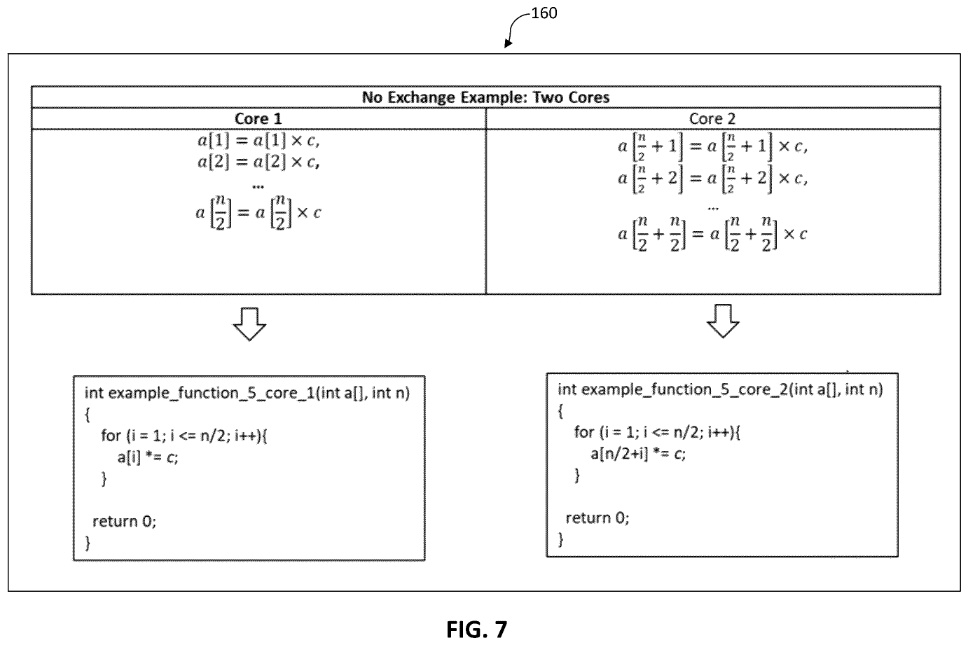

FIG. 7 is an example diagram 160 showing the equation versus “C” programming language form of a 1-dimensional array executing in parallel on two cores. Because the array is interacting with a constant value (via multiplication), which is not generated by either another task or another instance of the code (dynamic loop unrolling), no exchange of data takes place across the cores.

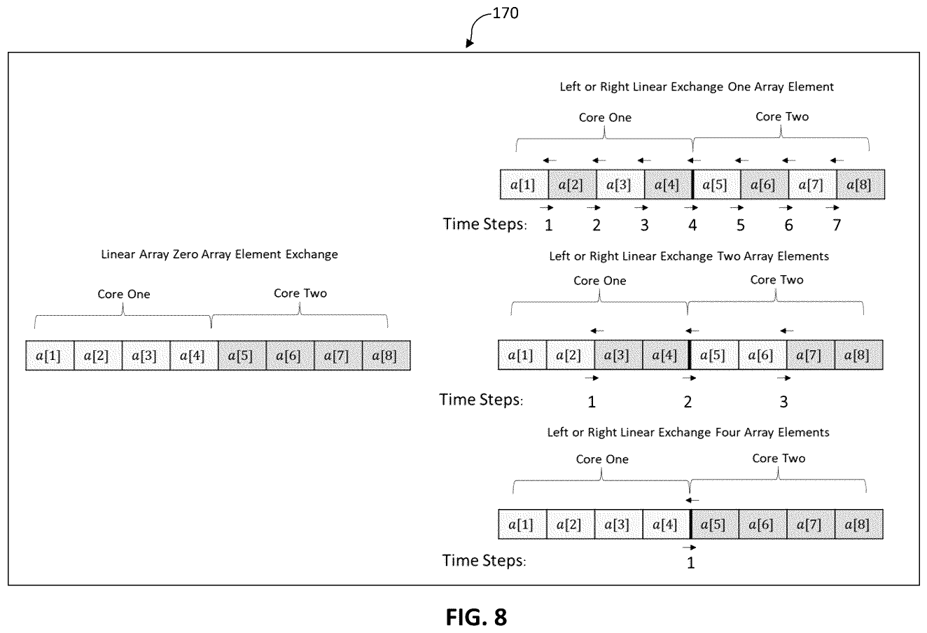

FIG. 8 shows a diagram 170 showing examples of a 1-dimensional linear array executing using two cores. The first 1-dimensional array shows a non-exchange, meaning there is no cross-communication between the two cores. The second 1-dimensional array is shown exchanging data with its adjacent array element, including cross-communication between array elements of the same 1-dimensional array across the two cores (across core processing boundaries, a[4] and a[5]), using either a left or right data exchange. The third 1-dimensional array is shown transmitting two adjacent array elements at a time, including cross-communication between array elements of the same 1-dimensional array across the two cores, using either a two-element left or two-element right exchange. The last 1-dimensional array is shown transmitting four adjacent array elements at a time, including cross-communication between array elements of the same 1-dimensional array across the two cores, using either a four-element left or four-element right exchange. These data exchanges are analogous to the FIG. 1 exchanges except on two cores.

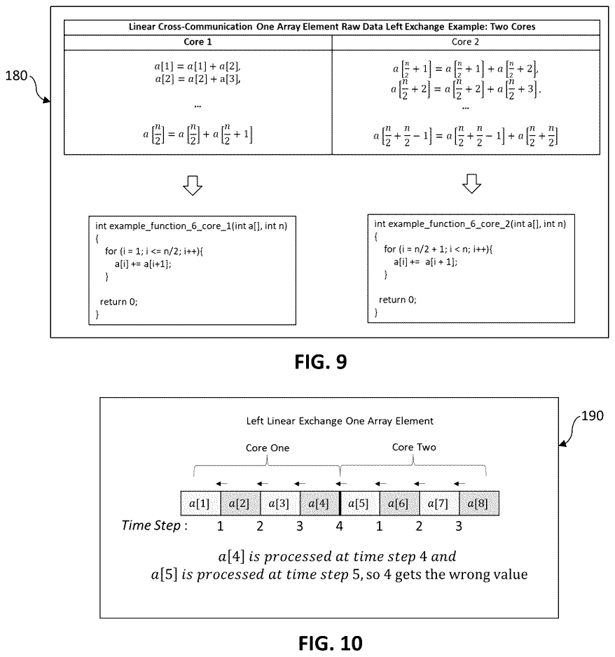

FIG. 9 is an example diagram 180 of two sets of equations, one per core, representing a left linear, single element exchange executing on two cores along with the associated “C” programming language depiction of those same left exchanges. Here the only place where there is the possibility of accepting the wrong data on a left linear exchange on two cores is when the left-most array element

$$index \frac{n}{2} ,$$

where n is the maximum number of array elements Since the first array element (on core one) does not interact with the last array element (on core two), the only exposed processing time problems can occur at the core boundary array elements,

$$\frac{n}{2} and \frac{n}{2} + 1 .$$

FIG. 10 is a diagram 190 showing the data transmission time steps on each of the two cores used in the left linear, single element exchange, executing on two cores as shown in FIG. 9. From examination of the time steps, the data that passes from array element a[5] executing using core two has already changed before it is transmitted to array element a[4] executing using core one. This leads to a computational error when the results are compared to that generated using a single core.

That is, the computed value is:

$$\begin{matrix} & Core 1 processing & Core 2 processing : \\ Time step 1 : & a [ 1 ] = a [ 1 ] + a [ 2 ] & a [ 5 ] = a [ 5 ] + a [ 6 ] \\ Time step 2 : & a [ 2 ] = a [ 2 ] + a [ 3 ] & a [ 6 ] = a [ 6 ] + a [ 7 ] \\ Time step 3 : & a [ 3 ] = a [ 3 ] + a [ 4 ] & a [ 7 ] = a [ 7 ] + a [ 8 ] \\ Time step 4 : & a [ 4 ] = a [ 4 ] + a [ 5 ] + a [ 6 ] & \end{matrix}$$

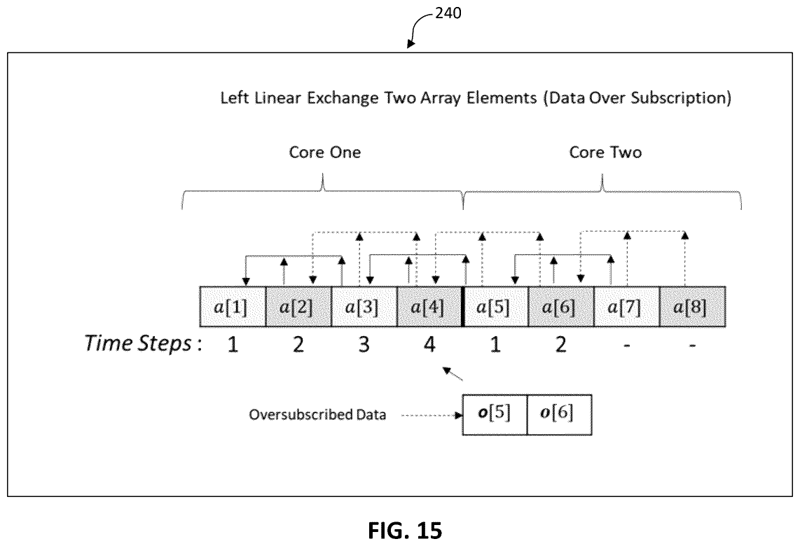

This is a calculation error for the underlying algorithm because a[5] is calculated at the same time as a[1] (time step 1) and well before a[4] (time step 4). Also notice that core one requires four time-steps to process, while core two only requires three time-steps. This processing time-step imbalance occurs because the processing cannot be performed on the value of a[8] as this is a 1-dimensional, left linear exchange (as opposed to a 1-dimensional circular exchange). As is shown in FIG. 15, the processing time-step imbalance can grow with the number of cores used in the exchange.

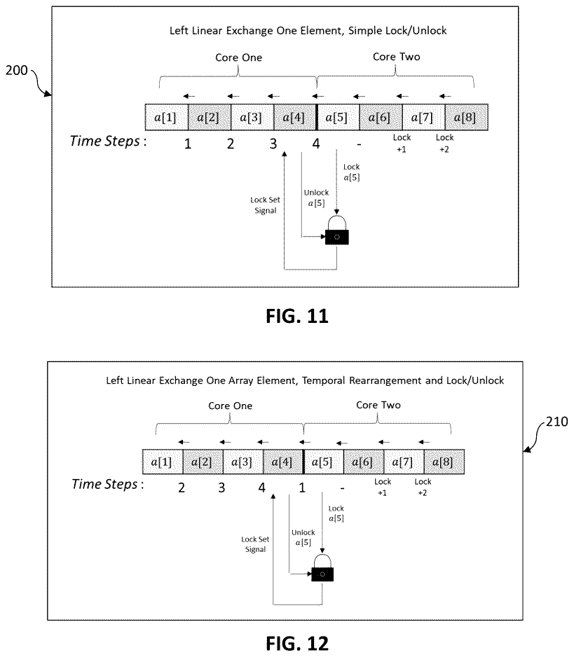

FIG. 11 is a diagram 200 showing a naïve approach to data locking. Locks are the traditional way to remove the parallel processing calculation error problem shown in FIG. 10. Before the problematic exchange in FIG. 10 occurs, the array element(s) in question can be locked, meaning that no problematic processing occurs. In this naïve lock example, array element a[5], whose calculation should start executing at time step 1, instead is locked until the calculation for array element a[4] is complete, ensuring that the correct data is used. Array element a[4], whose calculation should start executing at time step 4, instead will start executing at time step 1, ensuring that the minimum overhead time occurs. The calculation for array element a[4] must wait until the “lock set” signal is received from locking array element a[5].

Although the correct answer is calculated, the act of waiting for a lock to be set and then waiting to reset the lock adds overhead to the calculation, decreasing the effect of parallelization. In the example, if waiting on the lock to be set takes just one time step then core one (the slow side) would take five time-steps instead of the four used when calculating the incorrect answer, that is, a 25% increase in parallel processing time.

FIG. 12 shows a diagram 210 that in the example of FIG. 11, the array element processing times must be rearranged (the data exchange time steps reordered) as otherwise the two-core processing time would take at least as long to process as the single-core processing time. Consider that without rearranging the processing times, the a[4] calculation would not end until time step 4 (time step 5 when locking/unlocking is taken into account) so to ensure that the calculation is correct, a[5] would not start until time step 5 or 6. This means that the calculations on core two would not end until time step 7 or 8, which is, at best, the same as serial processing time and, at worst, slower than the serial processing time.

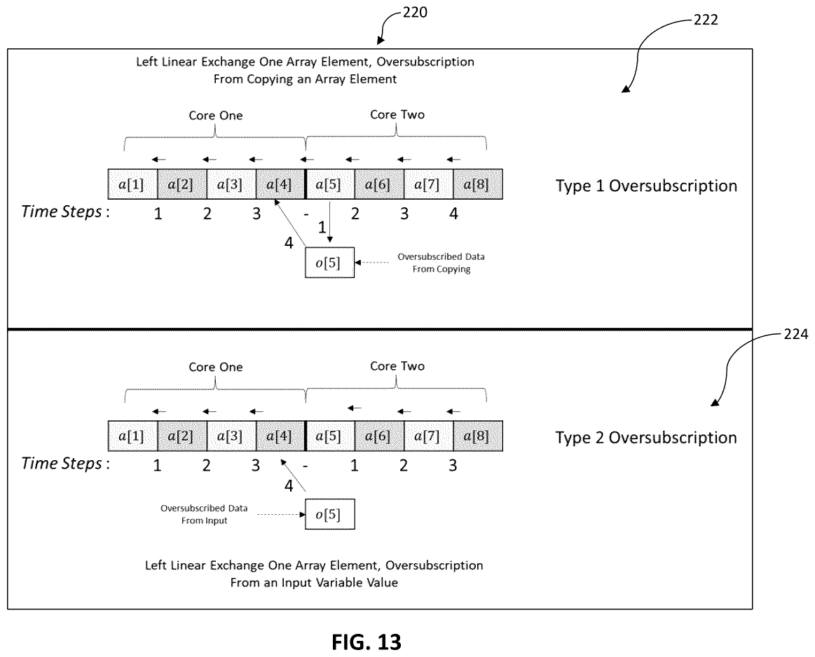

FIG. 13 shows a diagram 220 with two possible oversubscription solutions 222, 224, both of which remove the lock and replace it with the duplication of an array element. There is no temporal advantage between the solutions when a single array element is oversubscribed. From the lock use description in FIG. 12, it is clear that not using locks to solve the parallel calculation problem would be preferred. The first oversubscription solution 222 is when the oversubscribed data is copied from the transmitting core's array elements prior to use, allowing the receiving core to have the correct data while ensuring that the processing time is minimized. The second solution 224 is where the oversubscribed data is read in as part of the input data. Since the parallel processing time required is the maximum processing time of the parallel cores, the total processing time for either solution is shown to be four time steps for the current example. It should be noted that there is a temporal advantage using the second solution when the number of array elements required in the oversubscription is greater than one.

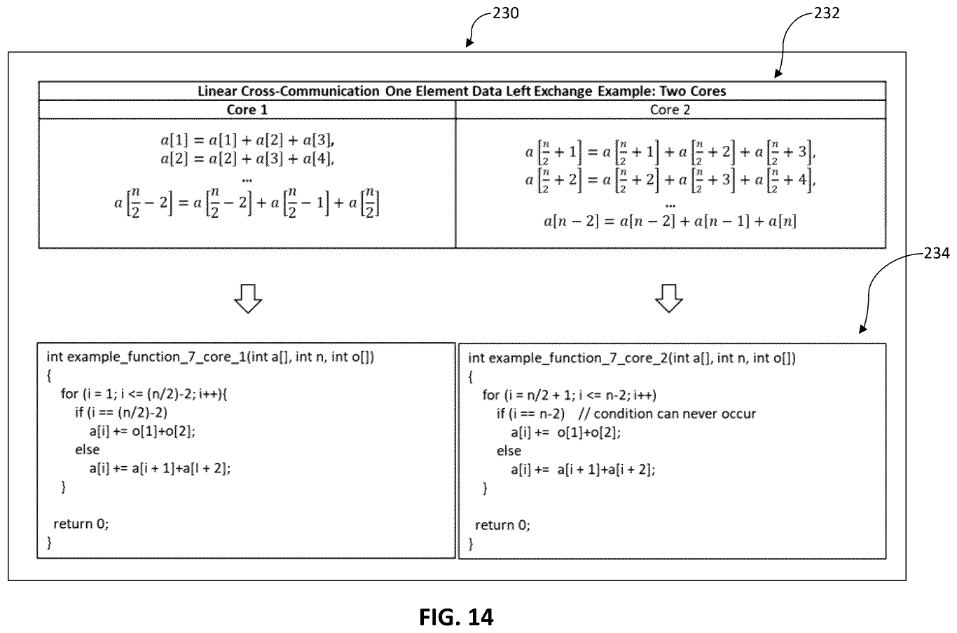

FIG. 14 is an example diagram 230 showing the equation versus the “C” programming language form of a 1-dimensional, left linear, two element exchange, executing on two cores, using one of the oversubscription methods. The first part of the example 232 depicts two lists of equations, one per core. These equations represent a series of left linear, two element exchanges. The equations do not show any oversubscription. The second part 234 of the example depicts the same 1-dimensional, left linear, two element exchange written in the “C” programming language and executing on two cores. Notice the starting and ending index values of the looping structure on each of the cores. The first core's loop index starts with the value 1 and ends with

$$\frac{n}{2} - 1 ,$$

whereas the second core's loop starting index is

$$\frac{n}{2} + 1$$

and ends with n-1. The input variable list on each core has the array “o”, which contains the two element oversubscription values. Here that oversubscription value is defined prior to calling the shown subroutine instances on each core.

FIG. 15 shows a diagram 240 of the 1-dimensional, left linear, two array element exchange using two oversubscription array elements, executing on two cores, shown in FIG. 14. Here the array elements o[5] and o[6] on the second core are oversubscribed for use by the array element a[4] on the first core. Notice that core one does substantially more work than core two, even though the number of array elements assigned to it are the same. This is because the number of array elements that must be shared limit the number of array elements involved in the calculation. Core one in this example has access to enough array elements (via oversubscription) to process all of its array elements, whereas core two only has enough array elements to process its first two array elements. Even though core two does less work than core one, total processing time is determined by the core one processing time because the processing time of multiple parallel cores is always the processing time of the slowest element.

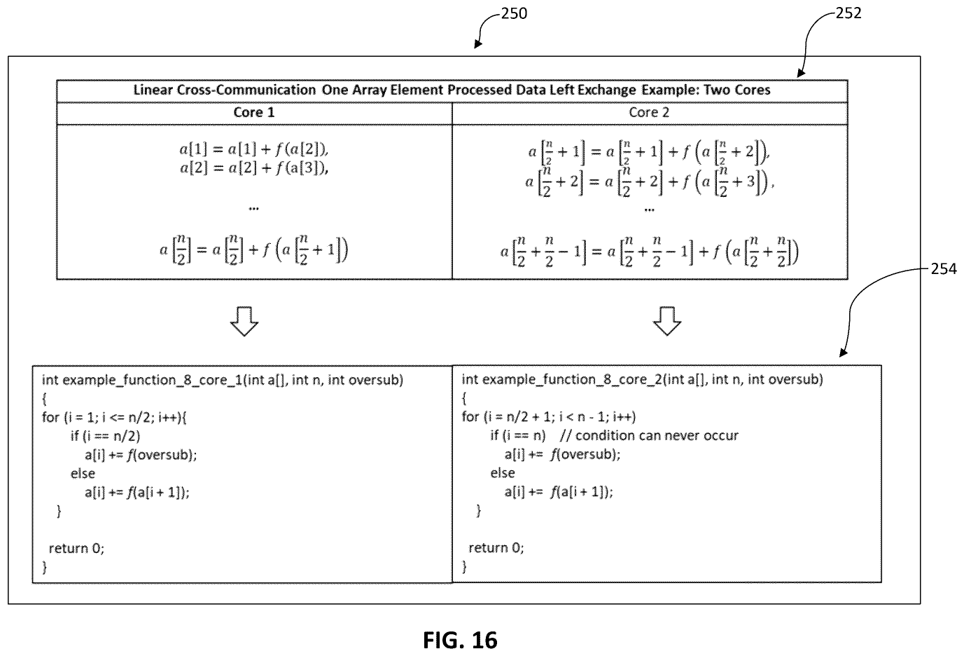

FIG. 16 shows an example diagram 250 of a 1-dimensional, left linear, two array element exchange, executing on two cores, depicted as two sets of equations, one per core, converted into “C” language software code. Unlike FIG. 14, this figure shows that the oversubscription effect works even in the case where a function is part of the data exchange. The first part 252 shows two lists of equations, one per core, whereby part of each equation shows an embedded function. The second part 254 of this figure shows the 1-dimensional, left linear, two array element exchange written using the “C” programming language executing on two cores. Here, prior to performing the exchange, the right-hand element is transformed by function “ƒ( )”. Notice that the oversubscribed array element is also subject to processing by the function.

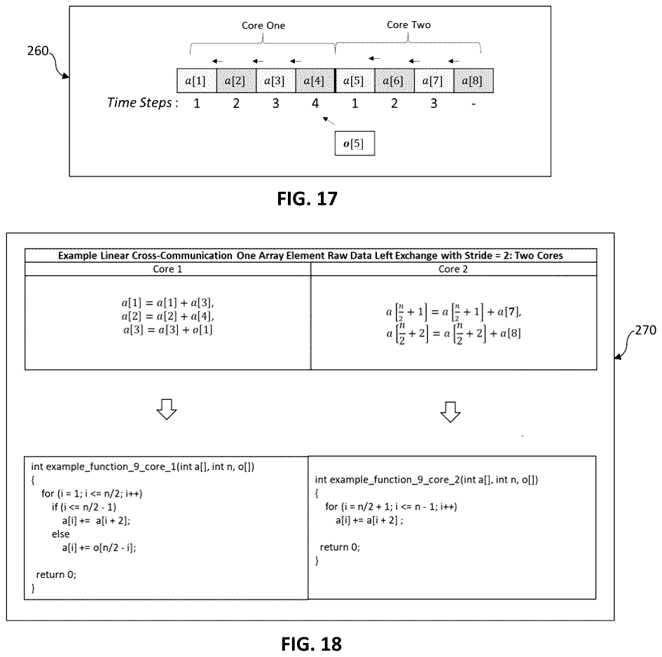

FIG. 17 shows a diagram 260 of the 1-dimensional, left linear, two array element exchange, executing on two cores, shown in FIG. 16, with a function of a succeeding array element being added to the unchanged array element. This means that the oversubscribed array element o[5] is processed by the function prior to its use by array element a[4]. Note that this example assumes that the function calculation (processing) takes one time step. It also assumes that creating the oversubscription f (o[5]) also takes one time step. Although a type 2 oversubscription is used here, because there is only one array element, a type 1 oversubscription would work as well.

FIG. 18 shows an example diagram 270 of a 1-dimensional, left linear, single array element exchange with a non-zero fixed stride depicted as two sets of equations, one per core, converted into “C” language software code, with oversubscription. A stride is when some array elements are skipped prior to performing the data exchange. That is, it is possible to have an exchange of non-contiguous array elements. Skipping some array elements so that other elements can be exchanged is called striding through the array elements. The simplest type of stride has a constant value. Here the fixed stride length is one element, meaning that every other array element is used.

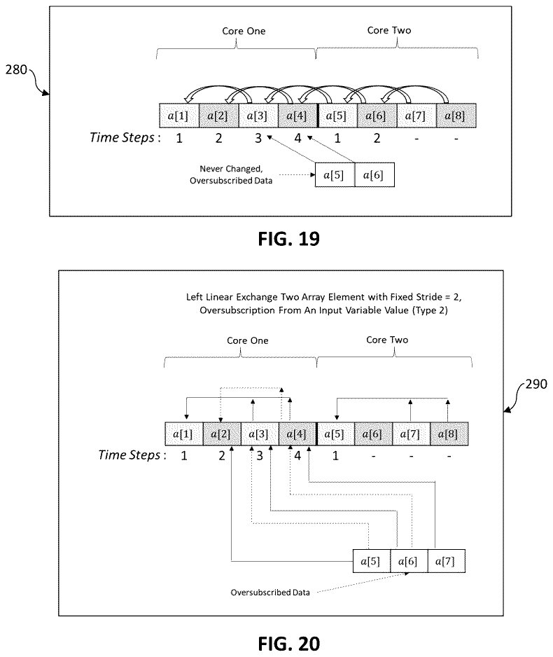

FIG. 19 is a diagram 280 of the 1-dimensional, left linear, single array element exchange with a non-zero fixed stride, using oversubscription, shown in FIG. 18. This example shows that the number of oversubscription array elements is the stride length minus one added to the number of array elements exchanged. This example uses the type 2 oversubscription method. The number of time steps required by the second core's exchange is far less than what is required by the first core. Although the maximum processing time is still only four time steps, the processing time is still unbalanced. This processing time imbalance can lead to problems with processing that follows the current exchange. Rebalancing is discussed below.

FIG. 20 is a diagram 290 that shows how the timing effect of FIG. 19 increases with the number of array elements exchanged. Here is shown a 1-dimensional, left linear, two array element exchange executing on two cores whereby the array element exchanges are not adjacent but have a fixed stride. This diagram shows that when two array elements are exchanged, both the stride and the number of oversubscribed array elements exchanged must be considered, highlighting how data exchange time step imbalances are exacerbated with striding. Type 2 oversubscription is used here because the number of array elements used in oversubscription is greater than one.

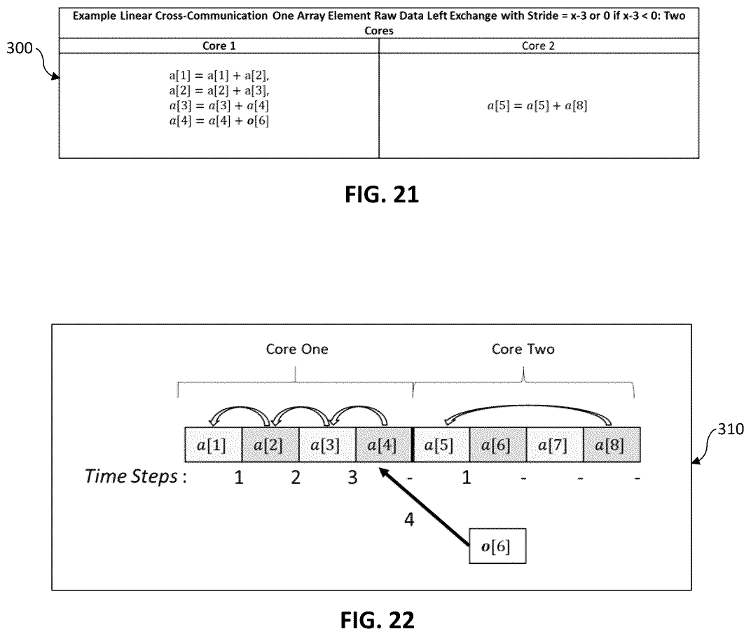

FIG. 21 shows a diagram 300 with two sets of equations, one per core, to highlight the use of variable strides with 1-dimensional, left linear, single element exchanges. That is, it is possible to have an exchange of non-contiguous array elements where stride length is a variable value.

FIG. 22 is a diagram 310 showing how the variable stride of FIG. 21 could interfere with the load balance of an array element exchange even with the use of oversubscription. Notice that only five of the eight array elements are engaged in the data transfer. This is indicative of poor workload management and would be inefficient to execute in parallel.

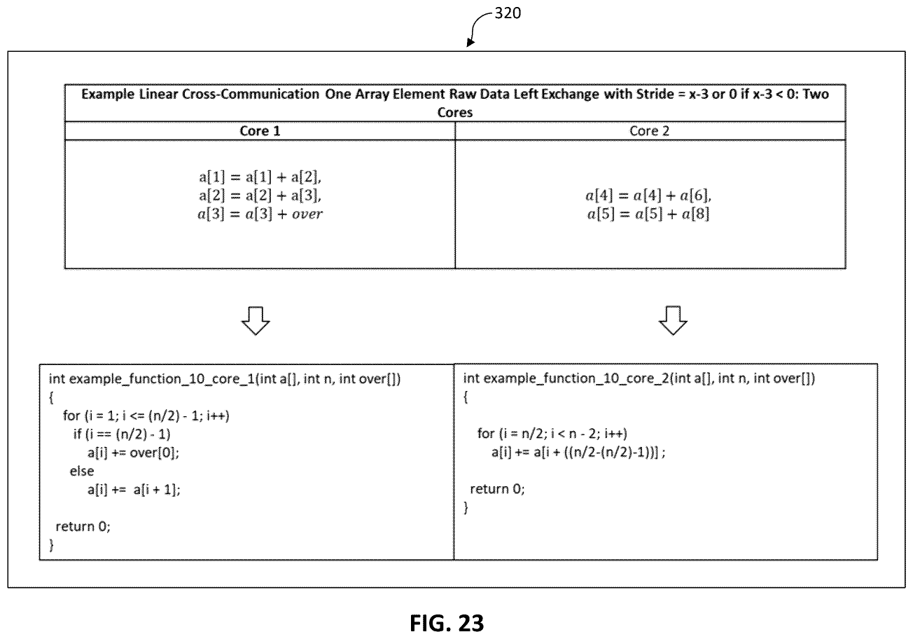

FIG. 23 is a diagram 320 showing the two sets of equations, one per core, used in FIG. 21, but in this case, since the last three array elements do not receive any data exchanges, it is possible to re-discretize the array elements across the cores, as shown here. Re-discretization combined with oversubscription is shown to be able to rebalance the processing time of the two cores.

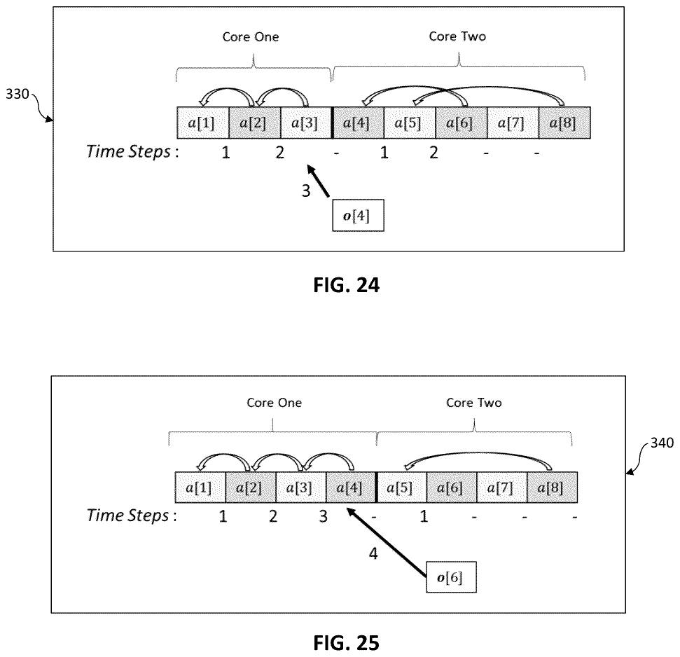

The diagram 330 of FIG. 24 is the diagram of FIG. 23 showing how re-discretization of the 1-dimensional, left linear, single element exchange, combined with oversubscription at the core boundary, can automatically make the variable stride workload-balanced enough to be effective using parallel processing with minimal impact on the processing that follows the exchange. Here, the variable stride is shown to follow this pattern: when the value of array element index x receives a data exchange and x-3<0, the exchange is from adjacent array elements, and when the value of array element index x receives a data exchange and x-3≥0, then the exchange uses a stride that increases by one for each value of x-3. Re-discretization combined with oversubscription allows for the workload-balancing of a much wider selection of data movements. These techniques are not limited to 1-dimensional exchanges but can be implemented using 1, 2, 3, or higher dimensional exchanges as well.

FIG. 25 is a diagram 340 showing a very unbalanced, naïve discretization with single array element exchanges, executing on two cores, using oversubscription. Re-discretization can be combined with oversubscription to convert this very unbalanced workload into a more balanced, lockless workload across two cores.

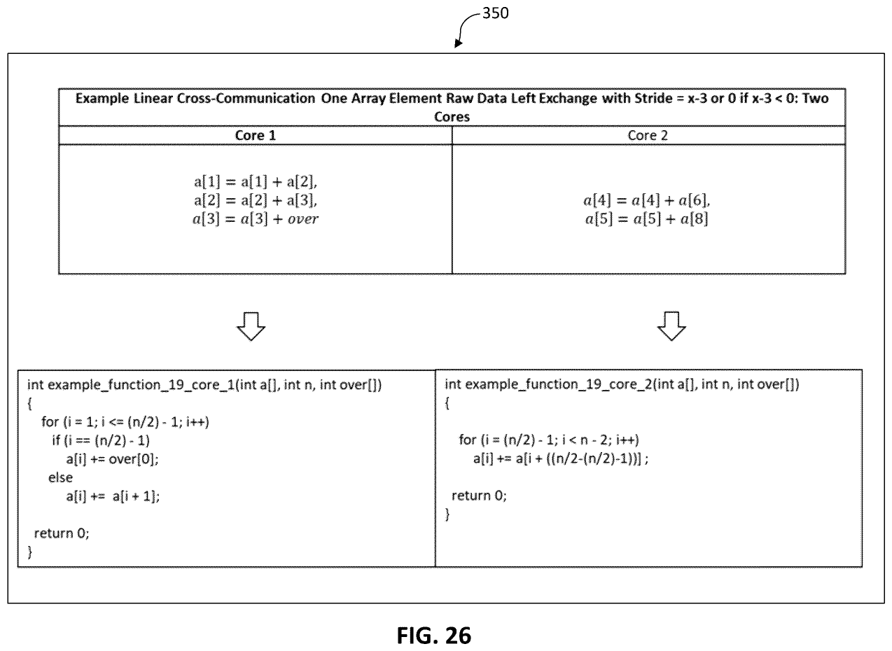

FIG. 26 shows a diagram 350 example of a 1-dimensional left linear, single array element exchange as both a set of equations, one per core, that have been re-discretized in a non-naïve fashion plus the “C” computer language version of the non-naïve discretized array, with oversubscription and the same variable stride pattern as shown for FIG. 24. Notice that the code is different on core two than that used for core one. This difference takes into consideration the different types of strides used in core two versus core one and can be calculated from the re-discretization.

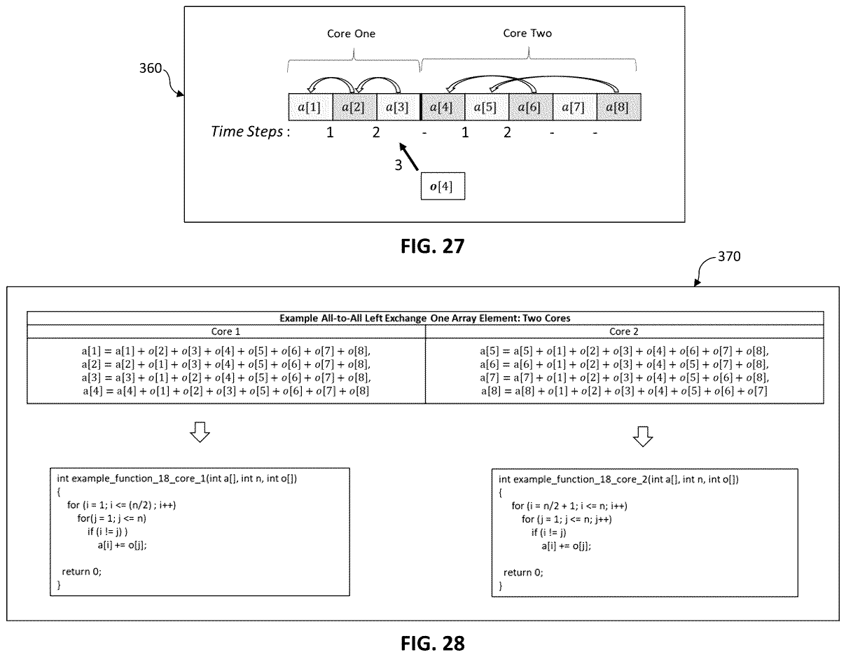

FIG. 27 is a diagram 360 of the re-discretized 1-dimensional, left linear, single array element exchange with the variable stride, executing on two cores, shown for FIG. 26. Notice that in addition to the re-discretization, there is also a change in the array element that is oversubscribed, which aligns the oversubscribed array element with the new boundary between core one and core two. The change in oversubscribed array element can be calculated from the re-discretization.

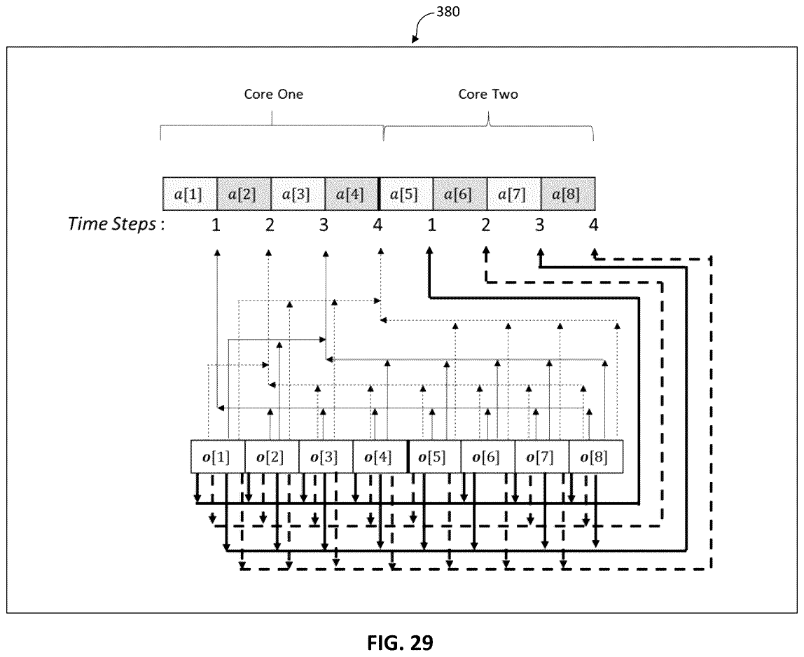

As shown in FIG. 28 and FIG. 29, with a shared memory model, which is the standard for a single server multi-core system, it is possible for the oversubscription to include all elements of the array. In the case of all-element oversubscription shown here, duplication of the entire array can significantly impact the memory required by the software code, meaning that before executing code with associated processing time prediction, it must be determined that there is sufficient memory. Sufficient memory is determined by using advanced space complexity associated with that code while the processing time is predicted using advanced time complexity associated with that same code.

FIG. 28 is an example diagram 370 showing the equation versus the “C” computer language form of a 1-dimensional, all-to-all left linear, single element exchange, executing on two cores, with an all-element oversubscription. An all-to-all exchange is where the contents of each array element utilize the contents of all other associated array elements in their calculations. Note that all-element oversubscription can be used for any exchange, it is always used for all-to-all, transpose, checkerboard, next-n-neighbor and other general data exchanges.

FIG. 29 is a diagram 380 of the 1-dimensional, all-to-all left linear, single element exchange, executing on two cores, using an all-element oversubscription shown in FIG. 28. It is an example of the pattern used to ensure that locks are not required for a 1-dimensional, all-to-all left linear exchange, regardless of the number of cores used, as long as there is sufficient memory within the server to hold both the 1-dimensional array and the oversubscribed values.

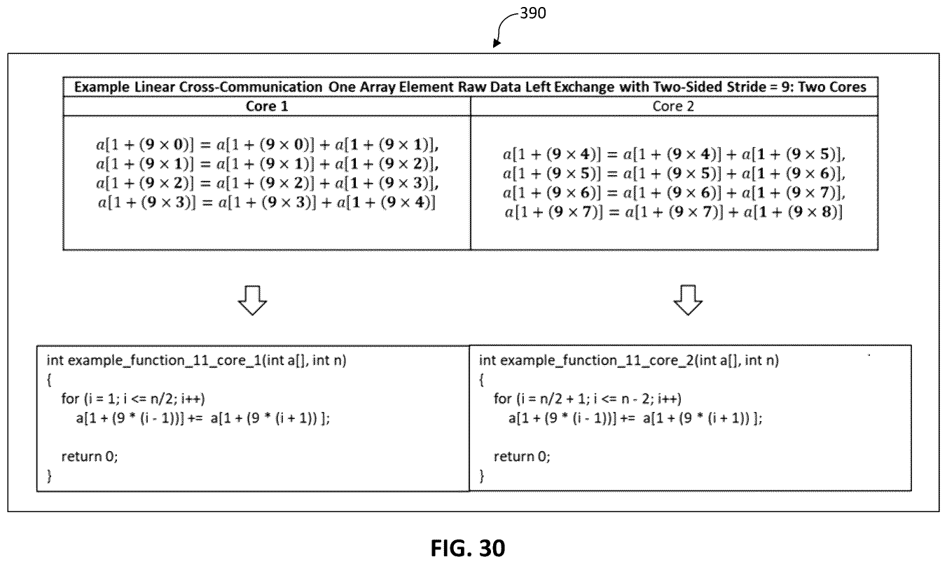

FIG. 30 is an example diagram 390 showing the equation versus “C” computer language forms of a 1-dimensional, left single element exchange, executing on two cores, on a 2-dimensional linear data structure such that both sides of the equations can vary, which is called herein a two-sided fixed stride. The exchanges discussed so far only fit memory locations for arrays that are either row- or column-oriented, that is, parallel to either the x or y axis. There is no reason why memory locations must be parallel to the x or y axis. For example, it is possible that the array elements of a 1-dimensional array that exists on a 2-dimensional linear data structure occur along a diagonal as shown here.

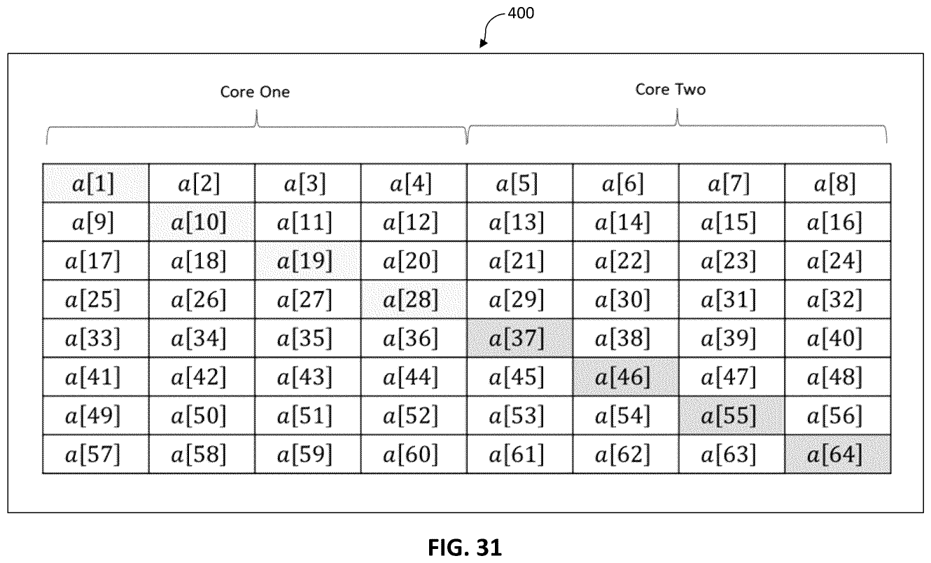

FIG. 31 is a diagram 400 of the 1-dimensional, left single element exchange, executing on two cores, on a 2-dimensional linear data structure shown in FIG. 30. This allows us to capture the full monotonic curve as shown here.

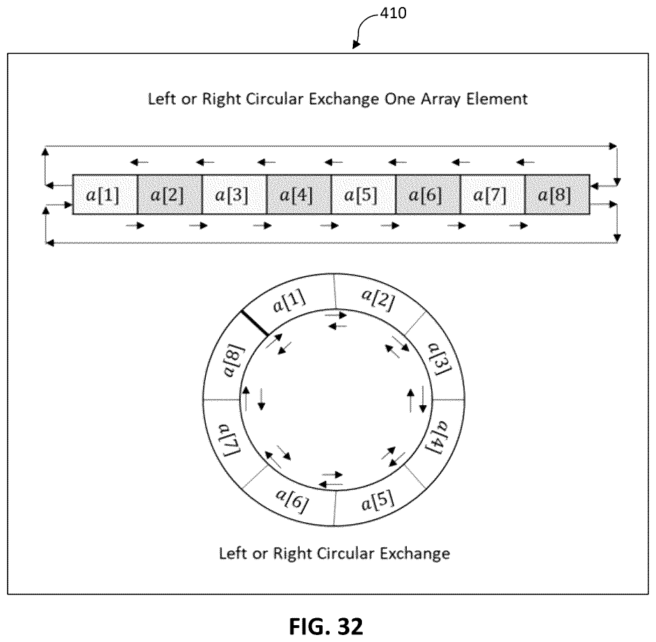

FIG. 32 shows a diagram 410 of two different ways of depicting a 1-dimensional, left or right single element data exchange, executing on a single core, on a circular data structure. These 1-dimensional left and right circular exchanges behave the same as the 1-dimensional left and right linear exchanges except at the end points. Unlike 1-dimensional linear exchanges, 1-dimensional circular exchanges include end-point communication, which is most easily shown as a circle.

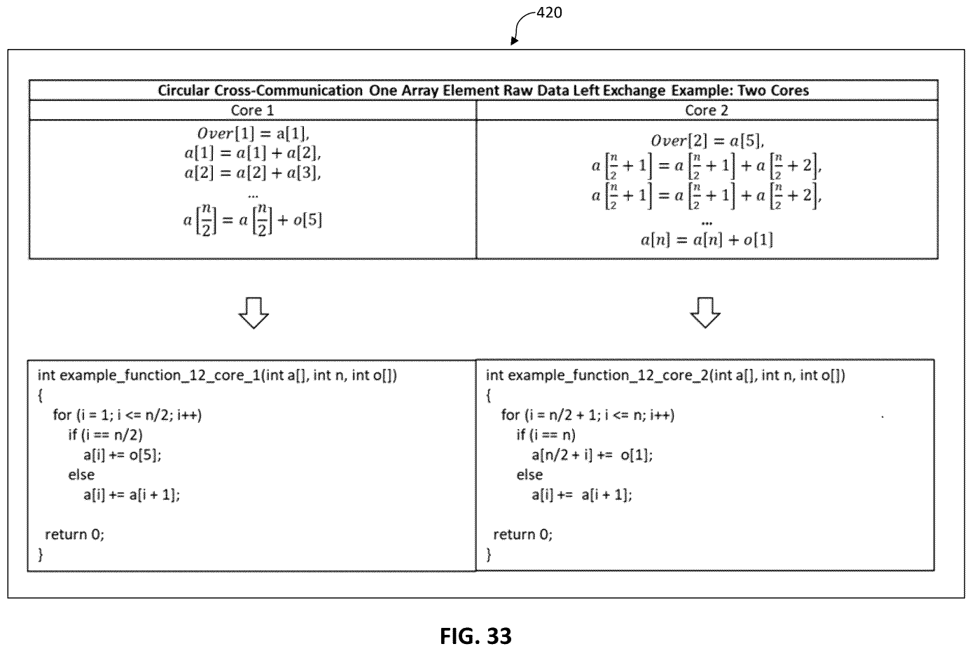

FIG. 33 is an example diagram 420 showing the equation form of a 1-dimensional, left circular, single element exchange with a fixed stride of one, executing on two cores, with double oversubscription, and the associated “C” computer language code. Core one uses the oversubscription value of array element o[5] while core two uses the oversubscription value of array element o[1], hence called herein double oversubscription. Note that double or triple oversubscription is more memory efficient than all-element oversubscription for circular, cylindrical, and toroidal data structures.

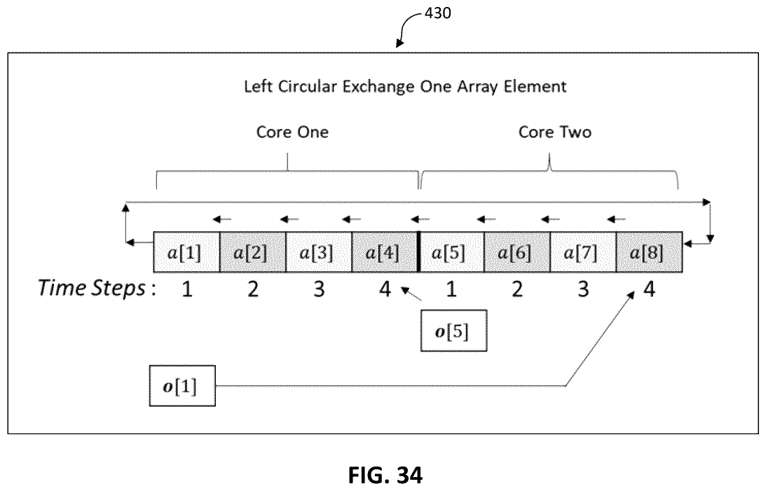

FIG. 34 is a diagram 430 of the 1-dimensional, left circular, single element exchange with a fixed stride of one, executing on two cores, using double oversubscription shown in FIG. 33. From FIG. 13, the left linear exchange of one array element on two cores requires only a single array element oversubscription. This is because there is only one interface between the two cores. In the eight-element array linear exchange examples, the core-to-core interface occurs between the fourth and fifth array elements. That is, the fifth array element (on core two) was used in the oversubscribed data transmitted to the fourth array element (on core one). With a left circular exchange of one array element with a stride of one on two cores, there are two interfaces between the cores. This is because, in addition to the fifth array element interfacing with the fourth array element across core boundaries, there is also the first array element (on core one) interfacing with the eighth array element (on core two). So, in addition to the linear exchange oversubscription of FIG. 13, double oversubscription shown here for a circular exchange is used when the data of the first element of the first core is transmitted to the last element of the second core.

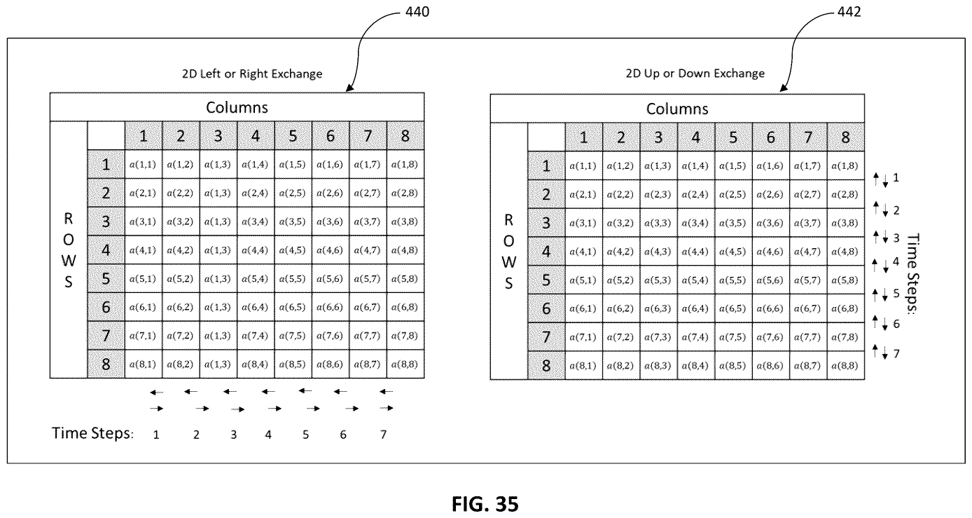

FIG. 35 shows two diagrams 440, 442 of single array element exchanges with a fixed stride of one, executing on one core, on a 2-dimensional linear data structure. The first diagram 440 shows a left or right linear exchange, and the second diagram 442 shows an up or down linear exchange. Notice that with a 2-dimensional linear exchange, the first and the last array elements for either a row or a column are not considered adjacent; that is, they do not exchange data.

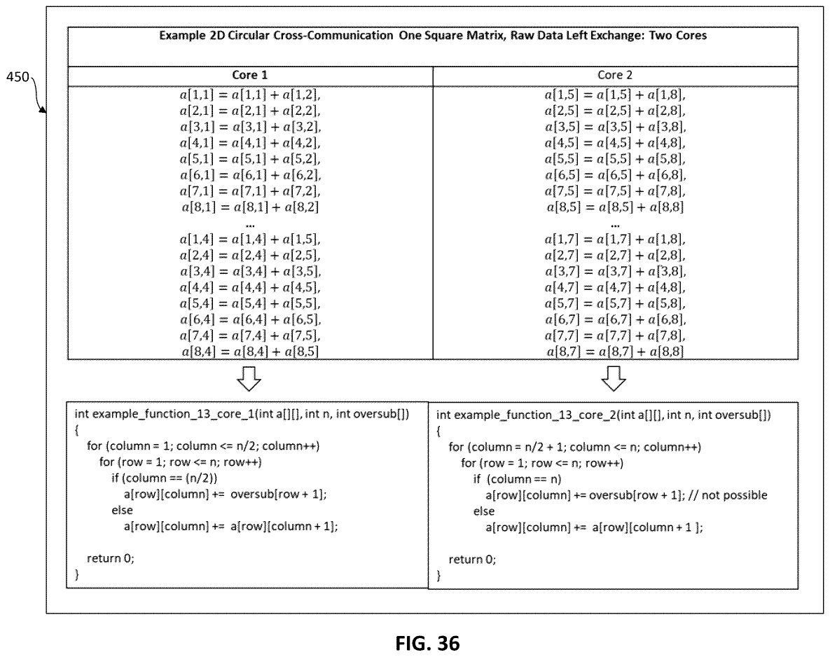

With regards to FIG. 36 through FIG. 39, note that exchanging array columns is analogous to left or right linear, single element exchanges whereas exchanging array rows is analogous to up or down linear, single element exchanges.

FIG. 36 is an example diagram 450 showing the equation form of a 2-dimensional, left linear, single column exchange with a fixed stride of one, executing on two cores, with column-based oversubscription, and the associated “C” computer language code, which shows the oversubscribed column as part of the input variables. Receiving the oversubscription column offers a more efficient solution than copying the column prior to use. As discussed in FIG. 13, moving an entire array column is equivalent to moving multiple array elements so oversubscription is more efficiently accomplished using type 2 oversubscription.

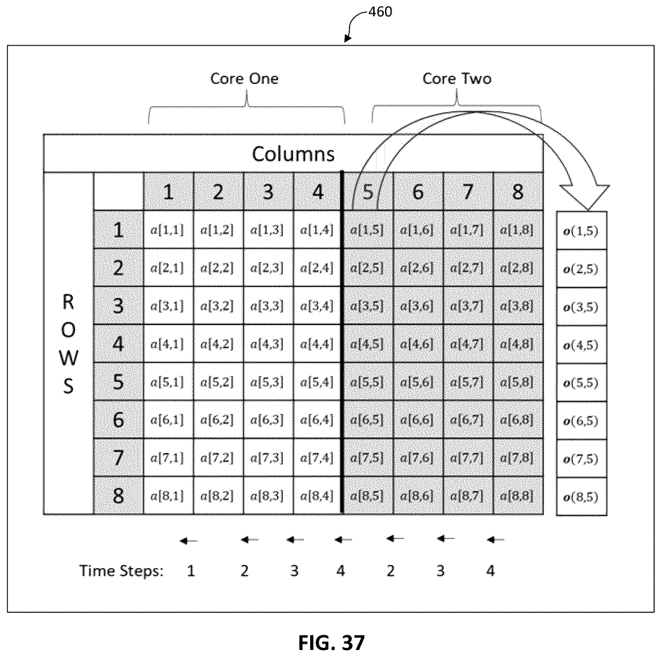

FIG. 37 is a diagram 460 of the 2-dimensional, left linear, single column exchange with a fixed stride of one, executing on two cores, using column-based oversubscription shown in FIG. 36. The single column exchange is analogous to the single element exchange in FIG. 13, using the appropriate oversubscription in each case to eliminate the need for locks. A square 2-dimensional matrix here uses the succeeding column's raw (unprocessed) data in its calculations. As with the 1-dimensional, left linear, single element exchange, the oversubscribed data is the data on the right side of the two-core data boundary. This diagram shows an eight-by-eight 2-dimensional array with an associated 1-dimensional column-based oversubscription at column 5.

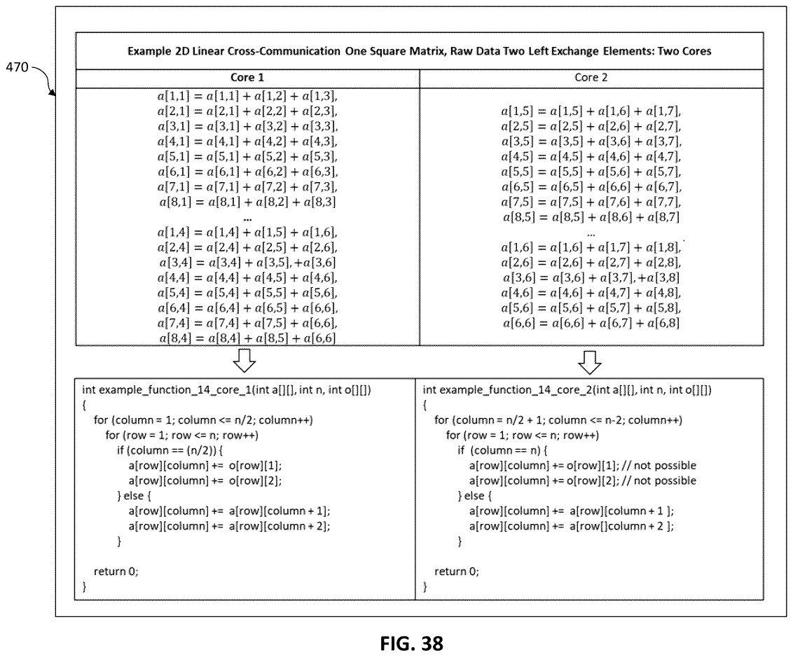

FIG. 38 is an example diagram 470 showing the equation form of a 2-dimensional, left linear, two column exchange with a fixed stride of one, executing on two cores, with column-based oversubscription, and the associated “C” computer language code, which shows the oversubscribed columns as part of the input variables. As discussed in FIG. 36, receiving the oversubscription columns is even more important in this case as there is twice the data in two columns as in one that would need to be copied prior to use. In this example, the oversubscription input, “o” is itself a 2-dimensional array because it holds two columns worth of data.

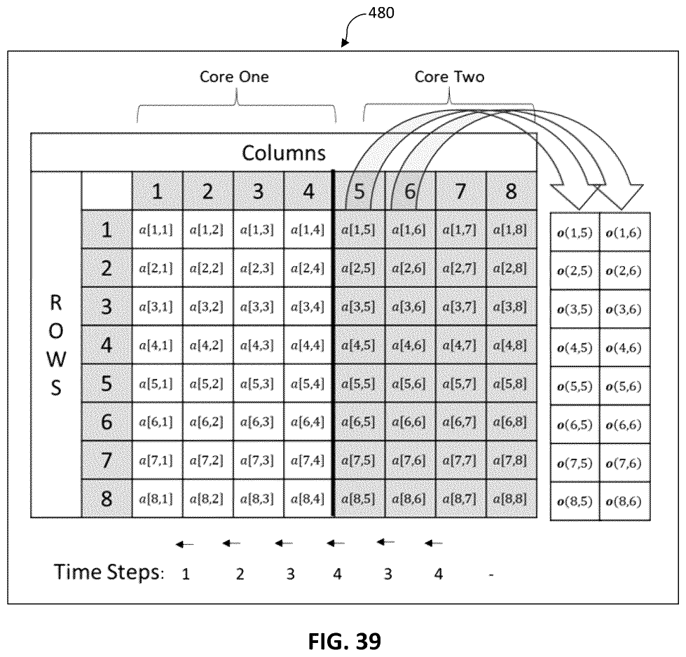

FIG. 39 is a diagram 480 of the 2-dimensional, left linear, two column exchange with a fixed stride of one, executing on two cores, using column-based oversubscription shown in FIG. 38. This is analogous to the 1-dimensional, left linear, two element exchange with a fixed stride of one, executing on two cores, using oversubscription of FIG. 15. Not that when more than one column or row is used in the exchange, the same number of columns or rows is used in the oversubscription.

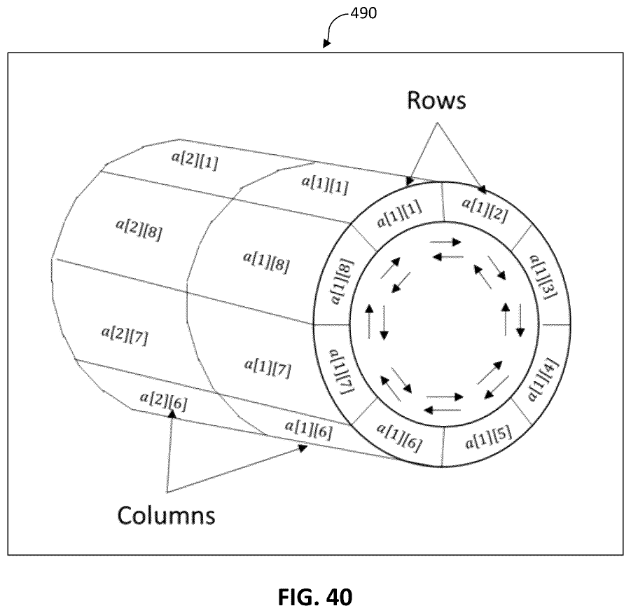

FIG. 40 shows a diagram 490 depicting a 2-dimensional, left or right single element data exchange, executing on a single core, on a cylindrical data structure. The difference between the up or down or left or right cylindrical exchange is what occurs at the row or column boundaries, which is where the first and last rows or columns of the array exchange data. This diagram highlights that the adjacency needed for these 2-dimensional exchanges is most easily shown as a cylinder.

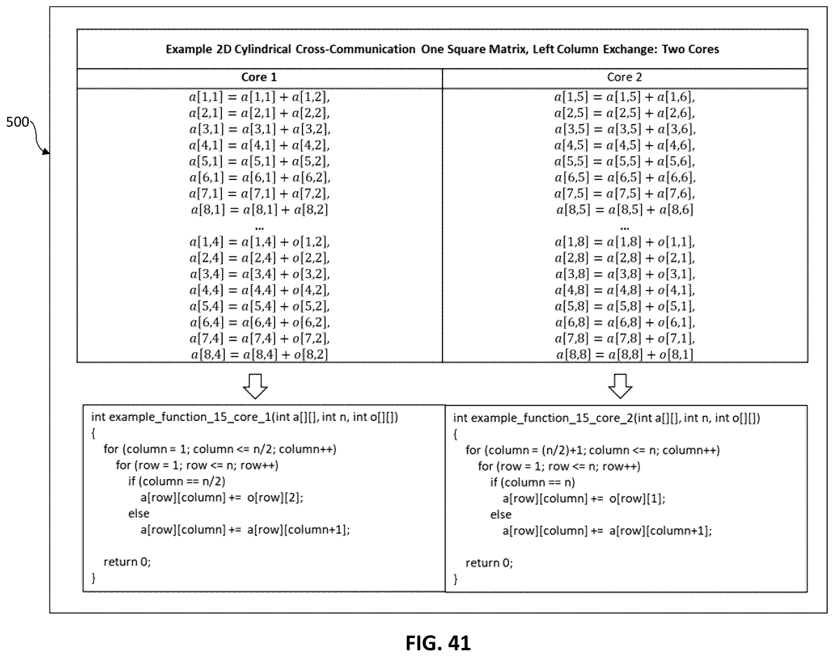

FIG. 41 is an example diagram 500 showing the equation form of a 2-dimensional, left cylindrical, single column exchange with a fixed stride of one, executing on two cores, with column-based double oversubscription, and the associated “C” computer language code. Column 1, which is the first column of core one, exchanges data with column 8, which is the last column of core two, and column 5, which is the first column of core two, exchanges data with column 4, which is the last column of core one. This column-based double oversubscription for a 2-dimensional, left cylindrical, single column exchange, is analogous to the double oversubscription for the 1-dimensional, left circular, single element exchange with a fixed stride of one shown in FIG. 33.

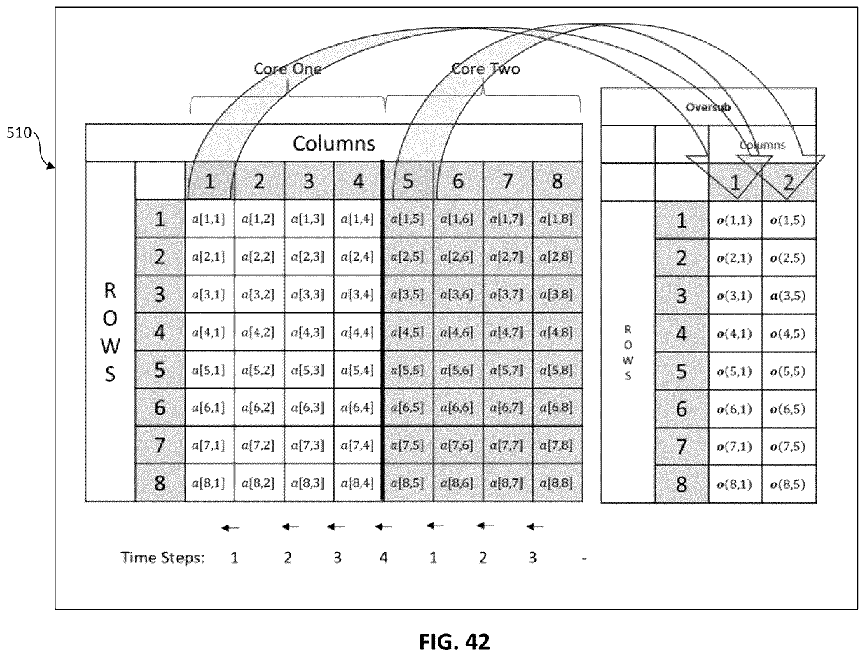

FIG. 42 is a diagram 510 showing the 2-dimensional, left cylindrical, single column exchange with a fixed stride of one, executing on two cores, using column-based double oversubscription shown in FIG. 41. Unlike the 2-dimensional, left linear, single column exchange shown in FIG. 37, which uses a single oversubscription column, the left cylindrical single column exchange here requires two oversubscription columns, one for each of the two core boundaries (exchanges between columns 1 and 8 or 5 and 4), thus, column-based double oversubscription.

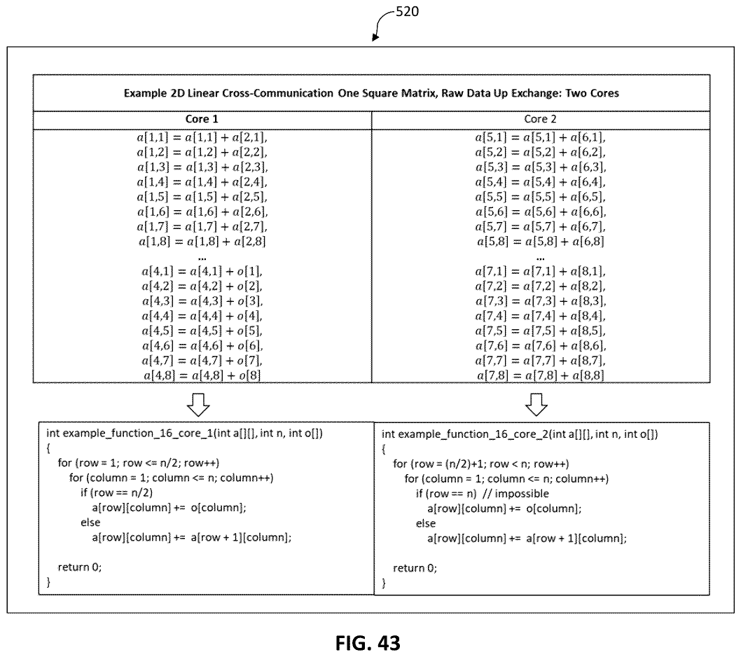

FIG. 43 is an example diagram 520 showing the equation form of a 2-dimensional, up linear, single row exchange with a fixed stride of one, executing on two cores, with row-based oversubscription, and the associated “C” computer language code.

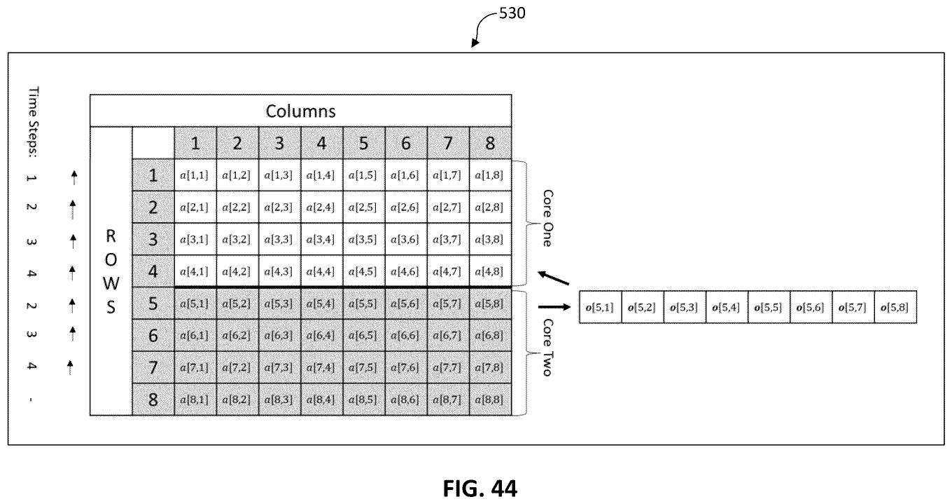

FIG. 44 is a diagram 530 of the 2-dimensional, up linear, single row exchange with a fixed stride of one, executing on two cores, using row-based oversubscription in FIG. 43. Like the 2-dimensional left linear, single column exchange shown in FIG. 37, the 2-dimensional up linear, single row exchange can use oversubscription to eliminate the need for locks.

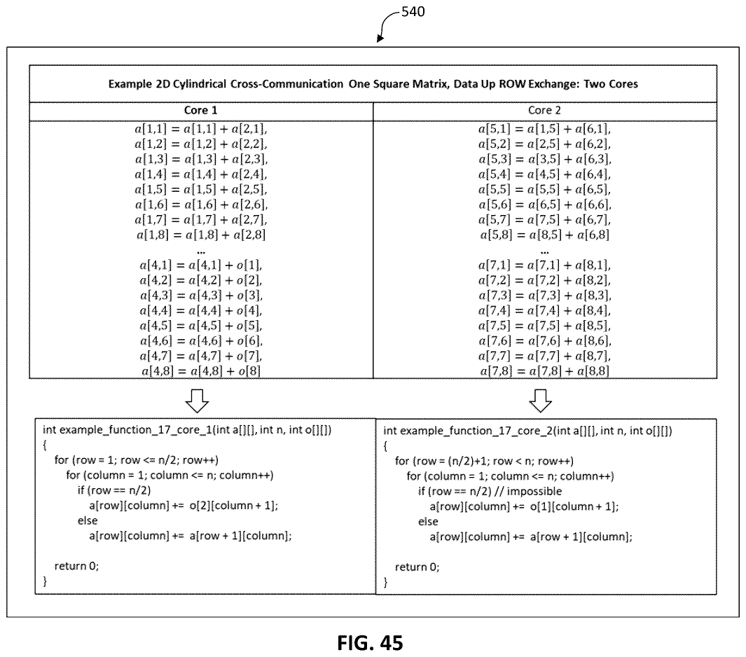

FIG. 45 is an example diagram 540 showing the equation form of a 2-dimensional, up cylindrical, single row exchange with a fixed stride of one, executing on two cores, with row-based double oversubscription, and the associated “C” computer language code.

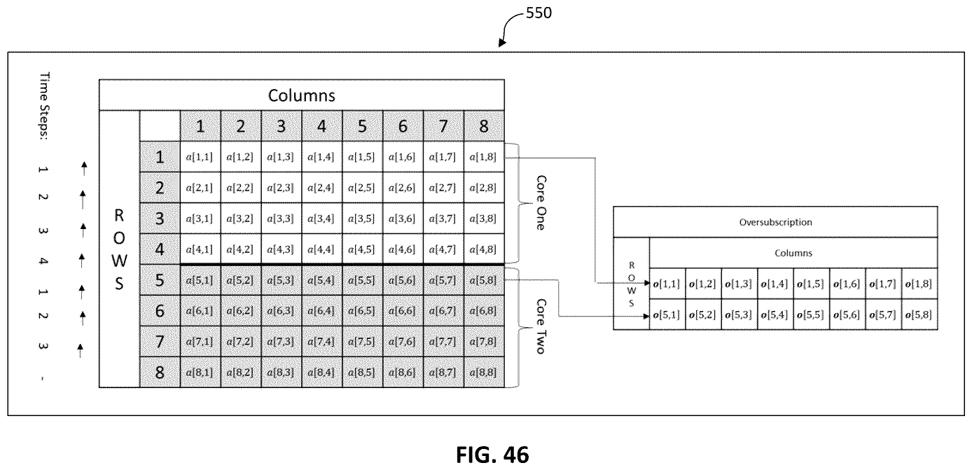

FIG. 46 is a diagram 550 of the 2-dimensional, up cylindrical, single row exchange with a fixed stride of one, executing on two cores, with row-based double oversubscription shown in FIG. 45. This is analogous to what is shown for columns in FIG. 42.

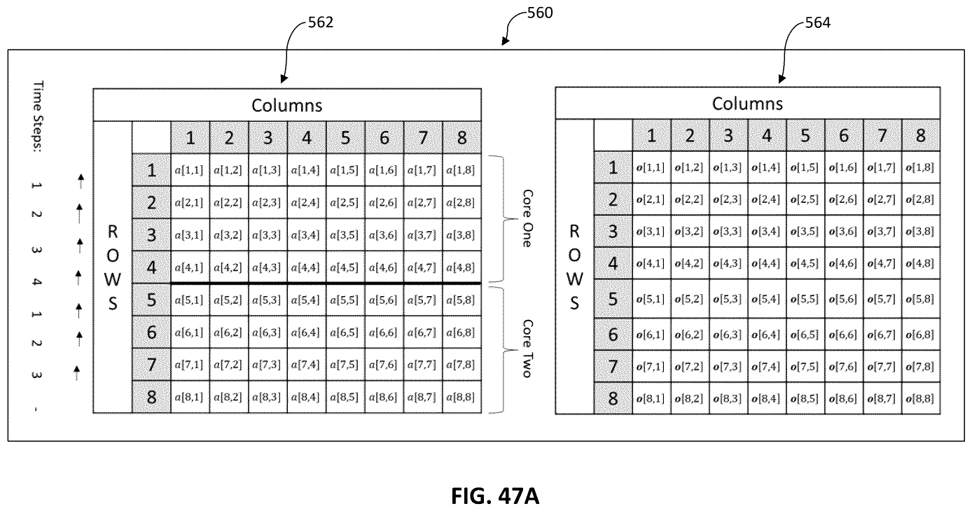

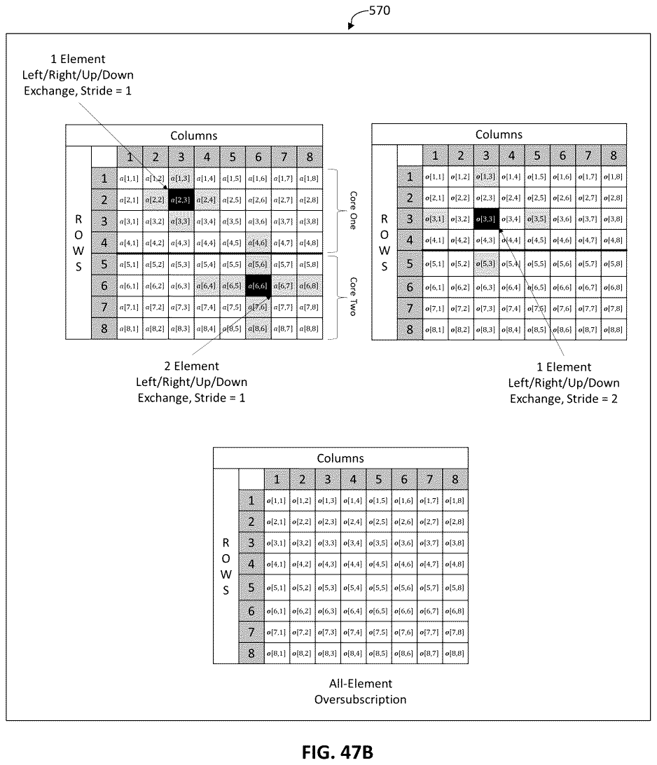

FIG. 47A is a diagram 560 of two 2-dimensional arrays 562, 564. The first 2-dimensional array 562 is executing on two cores while the second 2-dimensional array is stored in common memory accessible by either core and represents a duplicate of the first array's data. This second array 564 is used for all-element oversubscription that allows for a greater range of exchange types. A complete copy of the data is required for all-element oversubscription. All-element oversubscription is used with 1-dimensional all-to-all exchanges in FIG. 28 and FIG. 29. Because of the increased amount of data used in the oversubscription, it is more efficient to transmit the oversubscribed data at the same time as the array data, rather than using time to fill the oversubscription array with data. This technique can be used for raw (unprocessed) oversubscribed data as well as processed oversubscribed data. Note that all-element oversubscription can be used for any exchange, it is always used for all-to-all, left/right/up/down, checkerboard, next-n-neighbor, and other general data exchanges.

FIG. 47B is a diagram 570 of three left/right/up/down exchanges, executing on two cores, using all-element oversubscription, on 2-dimensional linear data structures. The first exchange is a single element left/right/up/down exchange with a stride of one. The second is a two-element left/right/up/down exchange with a stride of one. The third is a single element left/right/up/down exchange with a stride of two.

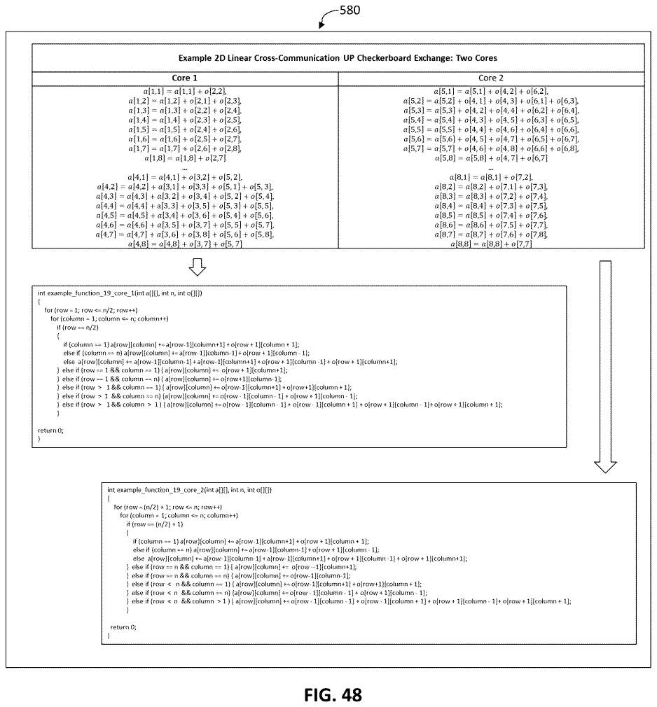

Referring to FIG. 48 through FIG. 54, the checkerboard single element data exchanges are processed in a diagonal manner: up left, up right, down left, and down right. All-element oversubscription as shown in FIG. 47A is always used for checkerboard exchanges.

FIG. 48 is an example diagram 580 showing the equation form of a 2-dimensional, up left linear, single element checkerboard exchange with a fixed stride of one, executing on two cores, with all-element oversubscription, and the associated “C” computer language code.

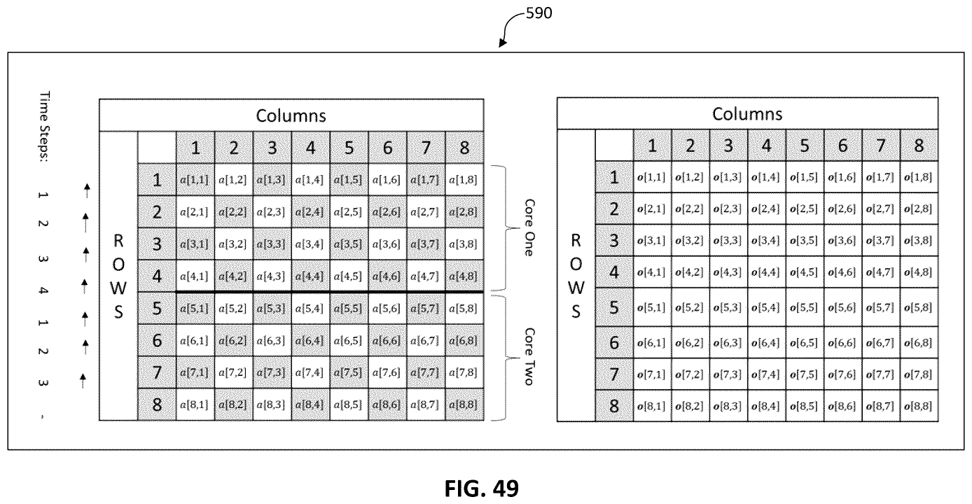

FIG. 49 is a diagram 590 of the 2-dimensional, up left linear, single element checkerboard exchange with a fixed stride of one, executing on two cores, using all-element oversubscription shown in FIG. 48. Depending on the receiving array element location, a checkerboard exchange uses data from one, two or four diagonally adjacent elements from the preceding or succeeding row and/or column. Checkerboard exchanges can be defined as up left, up right, down left, and down right.

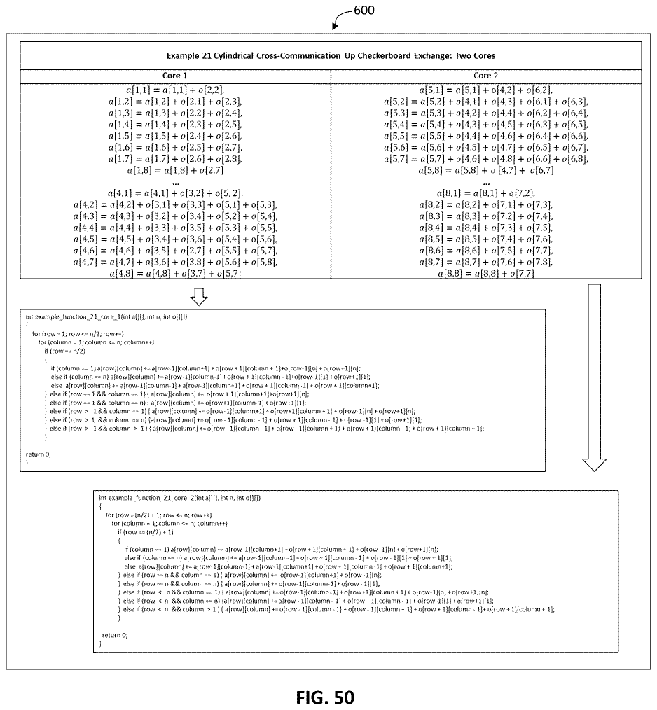

FIG. 50 is an example diagram 600 showing the equation form of a 2-dimensional, up left cylindrical, single element checkerboard exchange with a fixed stride of one, executing on two cores, with all-element oversubscription, and the associated “C” computer language code.

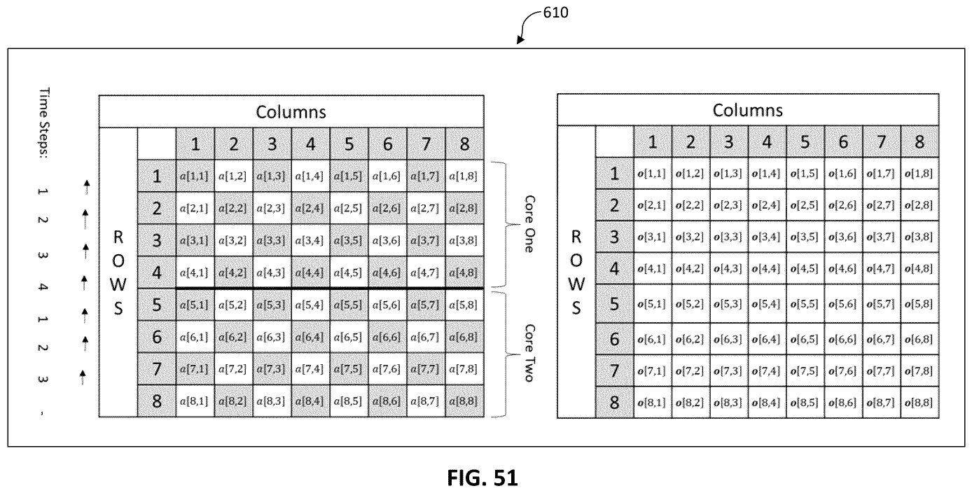

FIG. 51 is a diagram 610 of the 2-dimensional, up left cylindrical, single element checkerboard exchange with a fixed stride of one, executing on two cores, using all-element oversubscription shown in FIG. 50. Depending on the receiving array element location, a cylindrical checkerboard exchange uses data from two or four diagonally adjacent elements on the cylinder from the preceding or succeeding row and/or column.

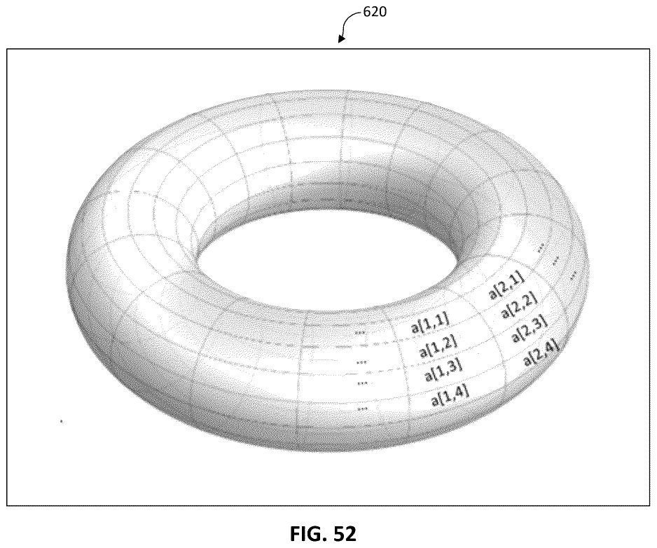

FIG. 52 is a diagram 620 showing an example of a 2-dimensional toroidal data structure. The difference between toroidal and cylindrical data structures is that for the latter, only one set of end points is part of an exchange; that is, either the first and last row or the first and last column are in communication. For the toroidal data structure, both the first and last row and the first and last column are in communication. As shown here, the shape formed when both the first and last columns and rows meet can be described geometrically as torus.

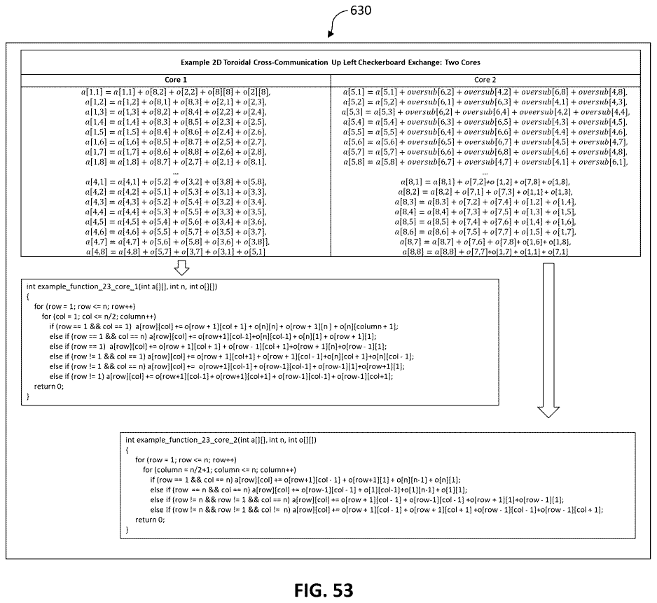

FIG. 53 is an example diagram 630 showing the equation form of a 2-dimensional, up left toroidal, single element checkerboard exchange with a fixed stride of one, executing on two cores, with all-element oversubscription, and the associated “C” computer language code.

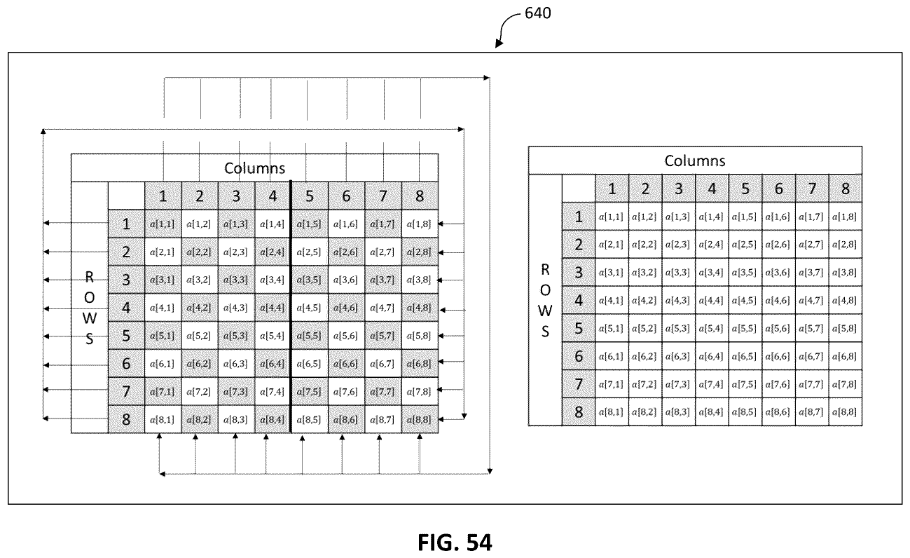

FIG. 54 is a diagram 640 of the 2-dimensional, up left toroidal, single element checkerboard exchange with a fixed stride of one, executing on two cores, using all-element oversubscription shown in FIG. 53. Note that triple oversubscription could be used with toroidal exchanges instead of all-element oversubscription and would be more memory efficient. Triple oversubscription is similar to the column-based double oversubscription shown in FIG. 42 with the addition of an oversubscription of the first row in that figure.

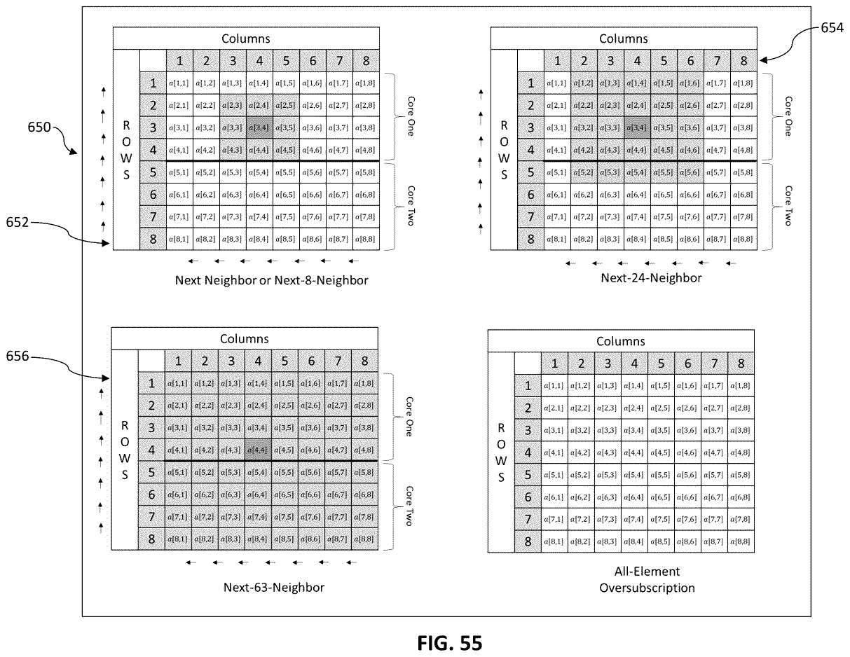

FIG. 55 shows a diagram 650 of three different types of next-n-neighbor exchanges on 2-dimensional linear data structures. Like the left/right/up/down and the checkerboard exchanges, the require all-element oversubscription, and all next-n-neighbor exchanges behave similarly. The only difference is the number of array elements involved in an exchange. These next-n-neighbor data exchanges can be on linear, cylindrical, or toroidal data structures. On a 2-dimensional linear data structure, the exchanges stop at the first and last row or column array boundary. On a cylindrical data structure, the exchanges include the first and last row or column in the exchange. On a toroidal data structure, the exchanges include both the first and last row and the first and last column in the exchanges. The first next-n-neighbor exchange 652 shows a linear single element next-8-neighbor (next neighbor) exchange with a fixed stride of one, executing on two cores, the second a next-24-neighbor linear exchange 654, and the third a next-63-neighbor linear exchange 656. Note that next-n-neighbor exchanges combine left/right/up/down and checkerboard exchanges, with horizontal, vertical, and diagonal data movements.

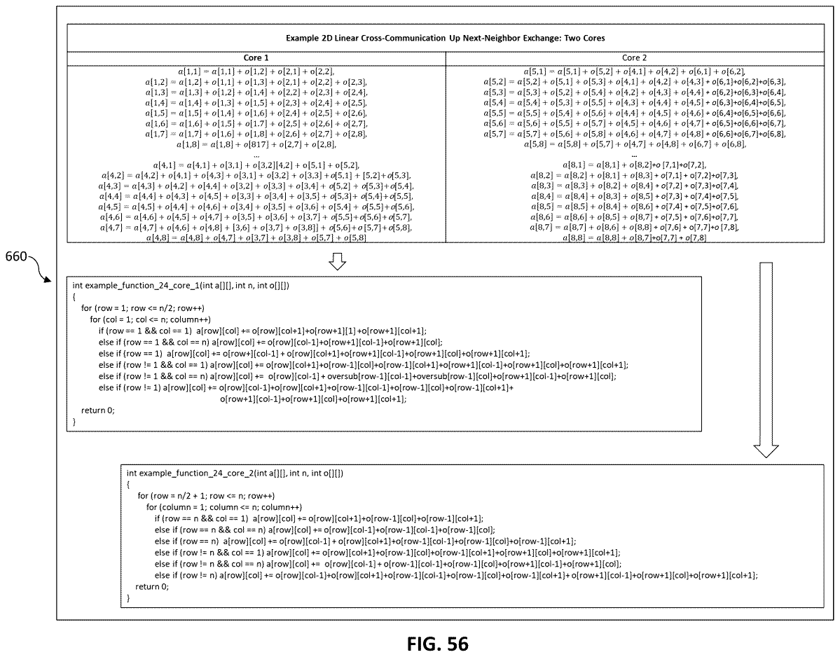

FIG. 56 is an example diagram 660 showing the equation form of a 2-dimensional, linear, single element next-neighbor exchange with a fixed stride of one, executing on two cores, with all-element-based oversubscription, and the associated “C” computer language code.

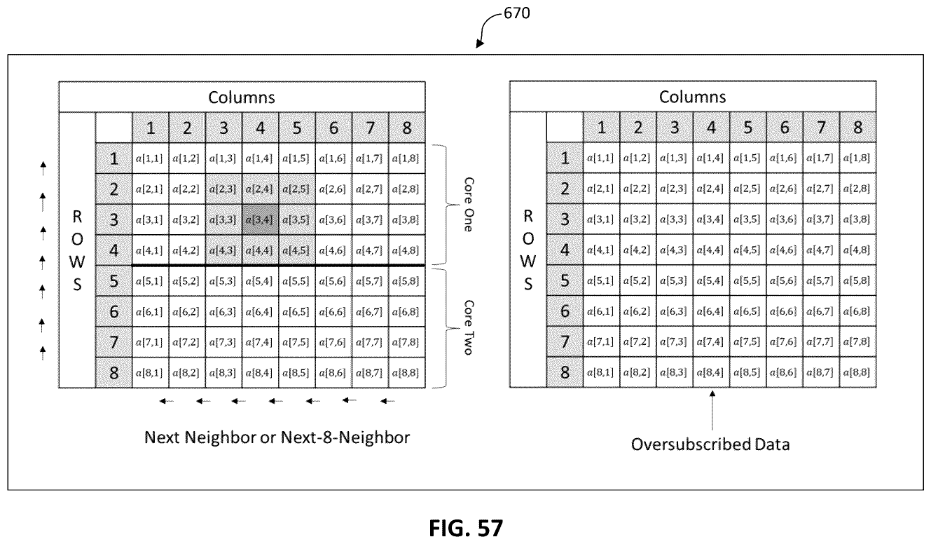

FIG. 57 is a diagram 670 of the 2-dimensional, linear, single element next-neighbor exchange with a fixed stride of one, executing on two cores, using all-element-based oversubscription shown in FIG. 56. Since the next-8-neighbor exchange is the simplest of the 2-dimensional next-n-neighbor exchanges, it is used to exemplify all of the next-n-neighbor exchanges.

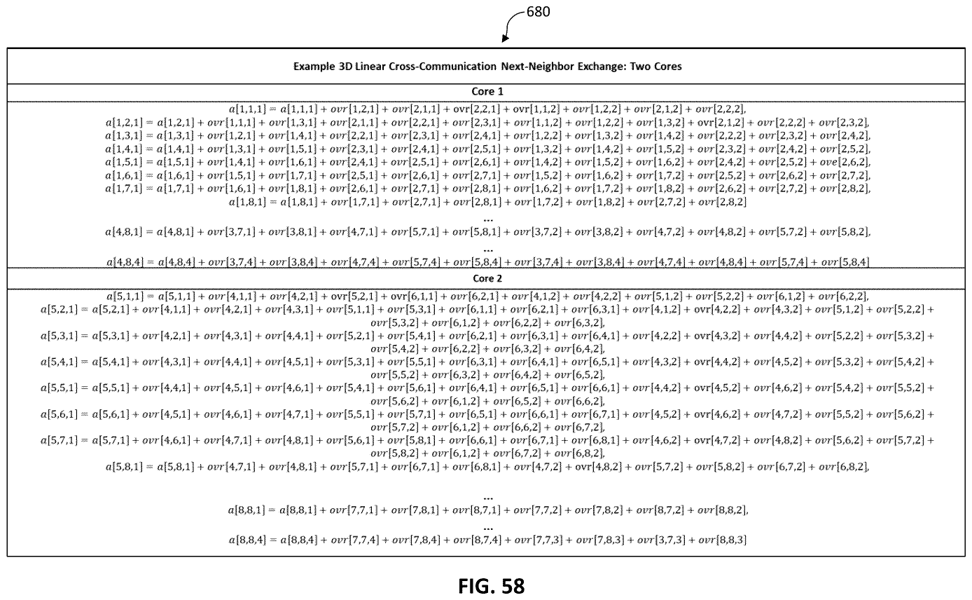

FIG. 58 is an example diagram 680 showing the equation form of a left/right/up/down/inner/outer single element next-neighbor exchange with a fixed stride of one, executing on two cores, with all-element-based oversubscription, on a 3-dimensional linear data structure. For 3-dimensional next-neighbor linear exchanges, inner/outer data exchanges are added to the 2-dimensional left/right/up/down and checkerboard data movements. Other 3-dimensional data exchanges on a 3-dimensional linear data structure behave analogously to their 2-dimensional counterparts as do 3-dimensional data exchanges on a cylindrical or toroidal data structure.

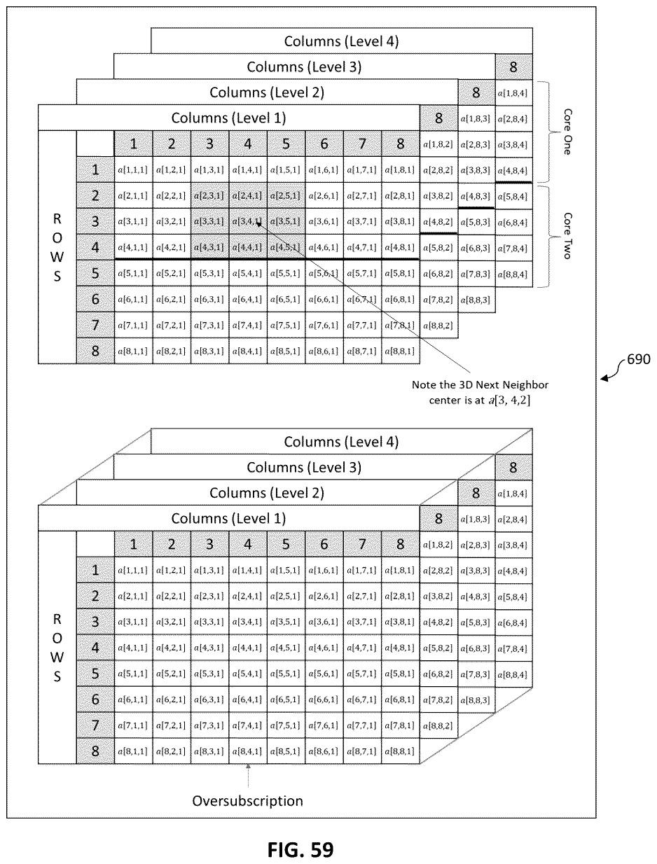

FIG. 59 is a diagram 690 of the left/right/up/down/inner/outer single element next-neighbor exchange with a fixed stride of one, executing on two cores, on a 3-dimensional linear data structure, using all-element-based oversubscription shown in FIG. 58. The linear 3-dimensional exchanges occur where none of the dimensional boundaries (first to last array element along a dimension) is used in an exchange.

With regards to FIG. 60A through FIG. 65D, there are two primary types of computing data exchanges: classical and quantum. Classical computing, which includes parallel processing, utilizes the structures outlined by Dr. Alan Turing in his definition of Turing machines. These machines can include one or more of CPUs, GPUs, Advanced Processing Units (APUs), Neural Processing Units (NPUs), TPUs, Data Processing Units (DPUs), FPGAs, and custom ASICs. Quantum Processing Units (QPUs) use q-bit technology to perform their processing. According Dr. Richard Feynman's work on the limits of computation, unless an algorithm contains inherently quantum effects (like superposition or entanglement), there was no physical or computational advantage to performing computations using quantum versus classical computing. Some of the conditions whereby a data exchange indicates inherently quantum effects are discussed herein. As with data exchanges using 2-dimensional cylindrical or toroidal and 3-dimensional linear data structures, the use of oversubscription and/or temporal reordering allows classical computers to execute 3-dimensional (or greater) lockless communication, greatly increasing performance.

For those algorithms that contain inherent quantum effects, either superposition or entanglement, there are major processing advantages. The question then is how a system can recognize when an algorithm contains superposition and/or quantum entanglement.

FIGS. 60A-60D are diagrams showing four data exchanges and when those exchanges increase the dimensionality of various arrays. In the first data exchange diagram of FIG. 60A (diagram 700), there is a left or right single element exchange on a 1-dimensional linear structure. In this case there is no dimensional transformation. In contrast, as shown in diagram 702, the second data exchange shows a left or right exchange on 1-dimensional circular data structure, which can be represented as a 2-dimensional data object. The third data exchange, as shown in FIG. 60B (diagram 704), is a left or right exchange on a 2-dimensional cylindrical data structure, which can be represented as a 3-dimensional data object. The fourth data exchange, as depicted in FIGS. 60C-60D (diagrams 706, 708), shows a left or right or up or down exchange on a 2-dimensional toroidal data structure, which can also be represented as a 3-dimensional data object.

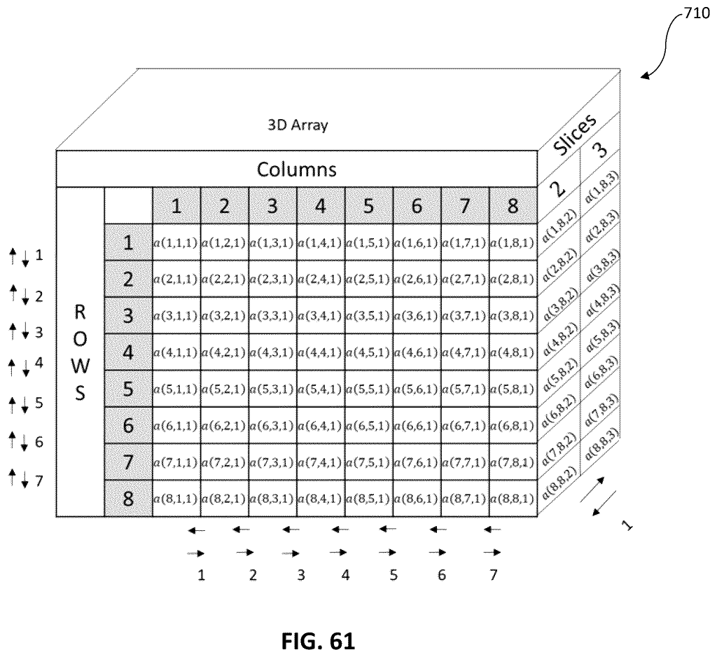

FIG. 61 is a diagram 710 showing a true 3-dimensional array with left/right/up/down/inner/outer exchanges. The difference between the 2-dimensional array and the 3-dimensional array is the addition of multiple “slices”.

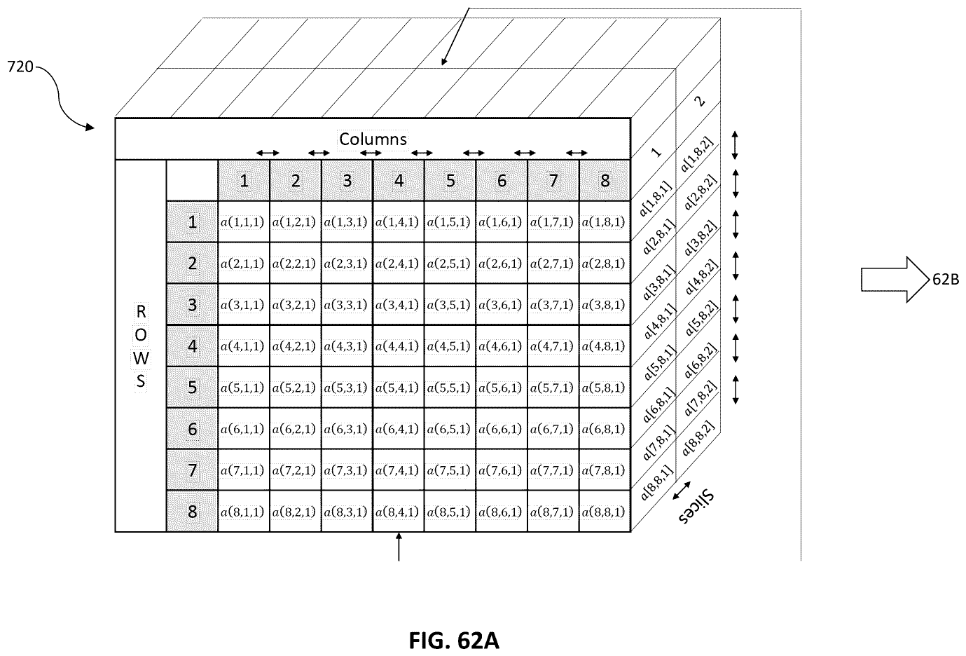

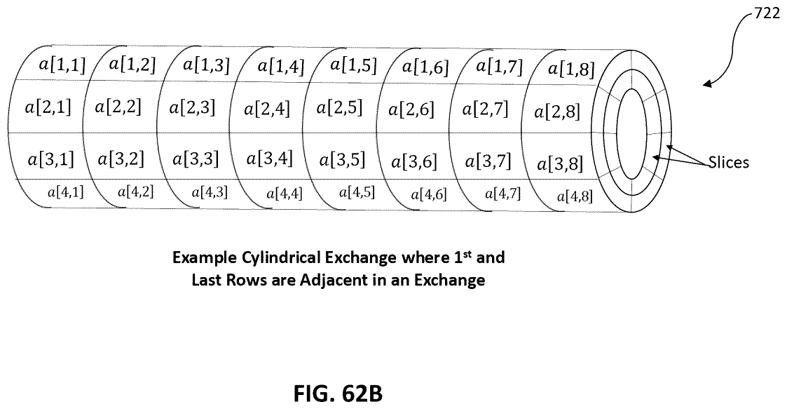

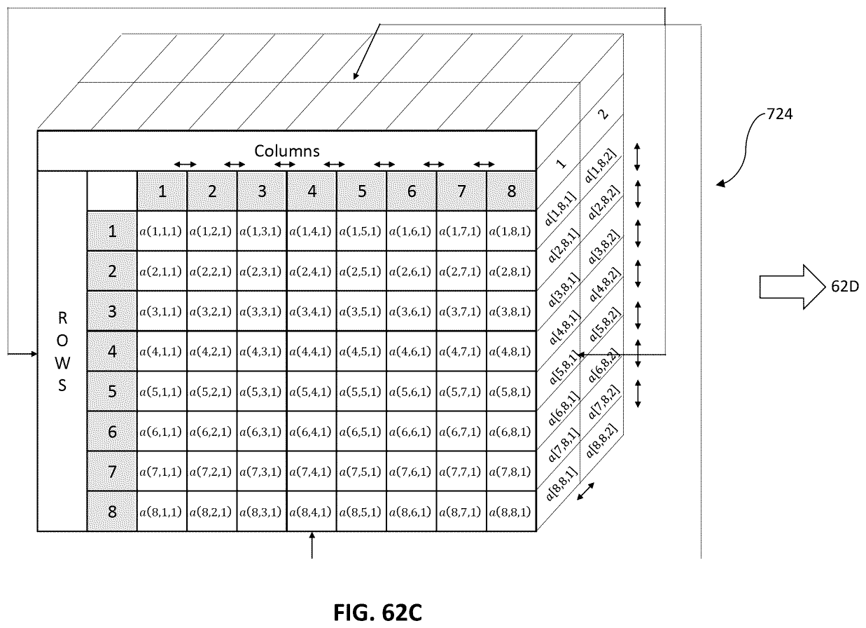

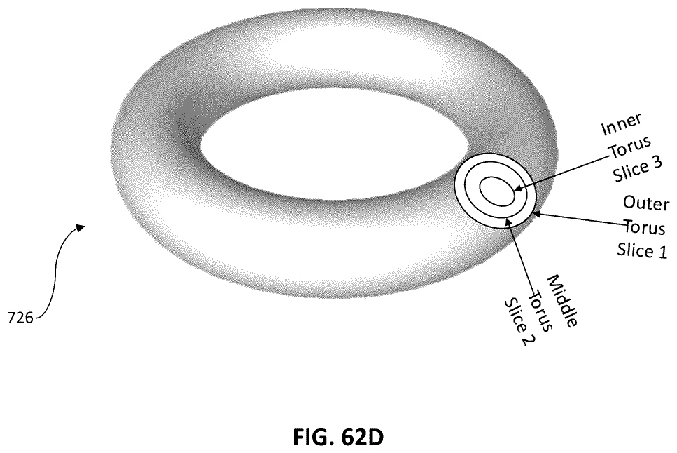

FIGS. 62A-62D show two examples of 3-dimensional array data exchanges. The first example, as depicted in FIGS. 62A-62B (diagrams 720, 722) shows a left or right or up or down or inner or outer exchange on a 3-dimensional cylindrical data structure, which can be represented as a 4-dimensional data object. This exchange differs from its 2-dimensional counterpart in that the first and last elements, as well as the other adjacent horizontal array elements, communicate. This can be contrasted with the 3-dimensional linear data structure where the first and last row elements do not exchange data. A cylindrical data structure can also be formed either from the first and last columns or the first and last slice. It should be noted that if the innermost and outermost slices are involved in a direct data exchange then such an exchange can take advantage of super-positioning, representing the first type of detectable algorithm-inherent superposition.

The second example, as depicted in FIGS. 62C-62D (diagrams 724, 726), shows a 3-dimensional toroidal data structure, which can be represented as a 4-dimensional data object. Unlike the 2-dimensional cylindrical or toroidal data structures, the 3-dimensional cylindrical or toroidal data structures add thickness to the walls of either the cylinder or torus. This example is of particular interest because of the data exchanges between the outermost slice and the innermost slice, which are used to determine when a data exchange can take advantage of superposition, representing the second type of detectable algorithm-inherent superposition.

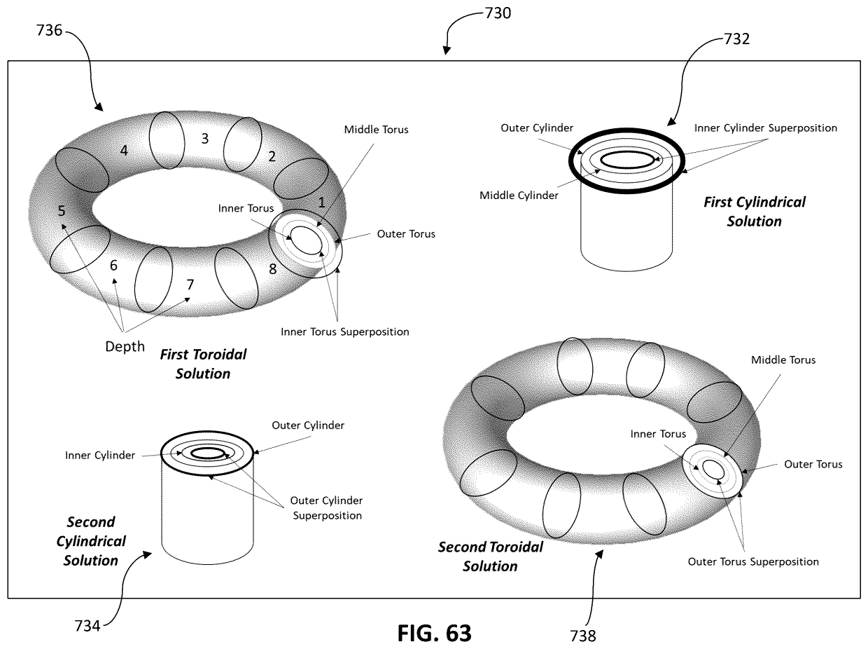

FIG. 63 shows four diagrams (within diagram 730) depicting two types of cylindrical (diagrams 732, 734) and toroidal (diagrams 736, 738) superposition advantage. Just as linking the ends of a 2-dimensional exchange means that the linked edges are adjacent, linking the edges of 3-dimensional cylinders or tori imply they are mathematically adjacent. Unfortunately linking the innermost slice with its corresponding outermost slice appears to require traversing all of the intervening slices. The problem of insuring adjacency without intervening slice traversal can be resolved by using the concept of quantum superposition.

For 3-dimensional cylinders and tori where the innermost and outermost slices are in direct communication, there are two possible quantum superposition solutions that would insure adjacency. The first solution is where the innermost cylinder or torus also exists outside of the associated outermost cylinder or torus, and the second solution is where the outermost cylinder or torus also exists inside of the associated innermost cylinder or torus. The first diagram (first toroidal solution) shows the innermost slice (inner torus) super-positioned outside of the outermost slice. The second diagram (first cylindrical solution) shows this same superposition but used for a segment of the torus, that is a cylinder. The third diagram (second toroidal solution) shows the outermost slice super positioned inside of the diameter of the innermost slice. The fourth diagram (second cylindrical solution) is the same as the third image solution but used for a segment of the torus, a cylinder.

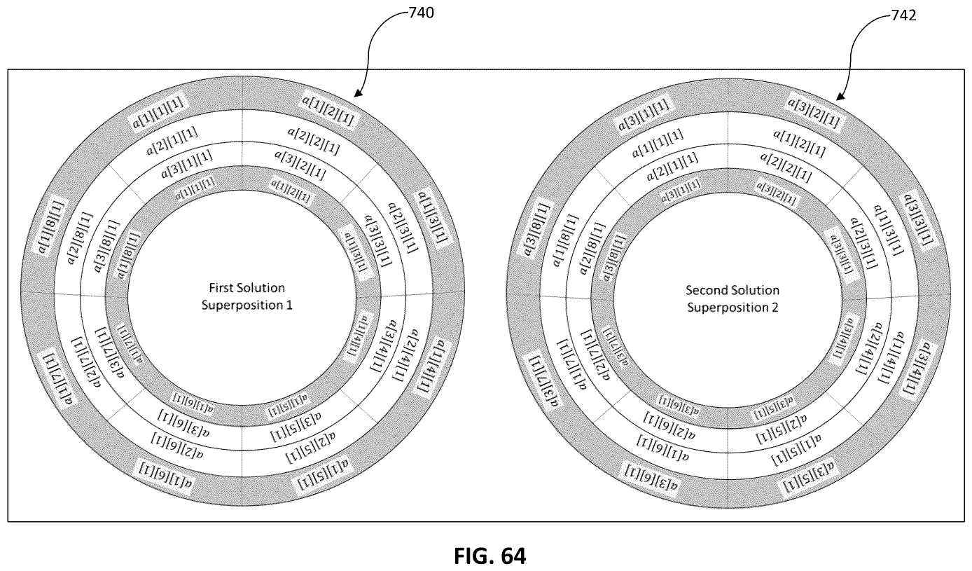

FIG. 64 shows two diagrams 740, 742, one for each of the two superposition solutions for the 3-dimensional cylindrical or toroidal single element exchange. These diagrams each show a cut-away detailed view of the various array elements. The first diagram 740 shows that the array elements of the outermost slice are adjacent to the innermost slice via superposition. This effectively means that the outermost slice appears in its normal position and adjacent to the inner diameter of the innermost slice. For example, data from array element a[1] [1] [1] can be exchanged directly with element a[2] [1] [1] or element a[3] [1] [1] without traversing any intervening slices. Similarly, the second diagram 742 shows that the array elements of the innermost slice are adjacent to the outermost slice via superposition. This effectively means that the innermost slice appears in its normal position and adjacent to the outer diameter of the outermost slice.

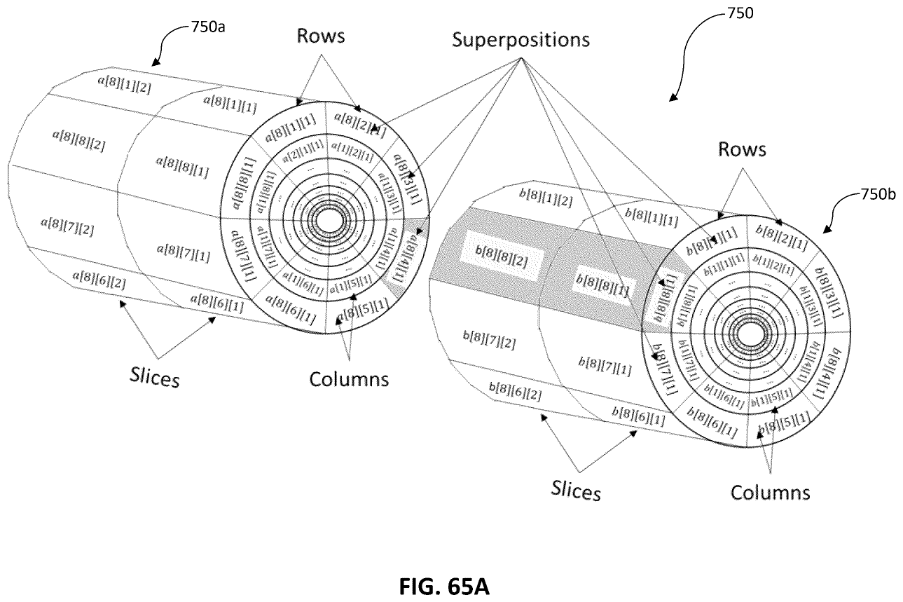

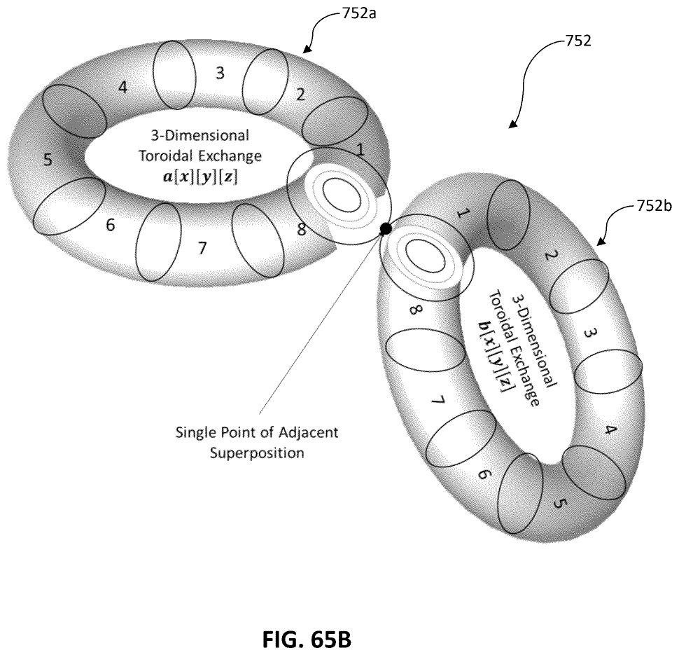

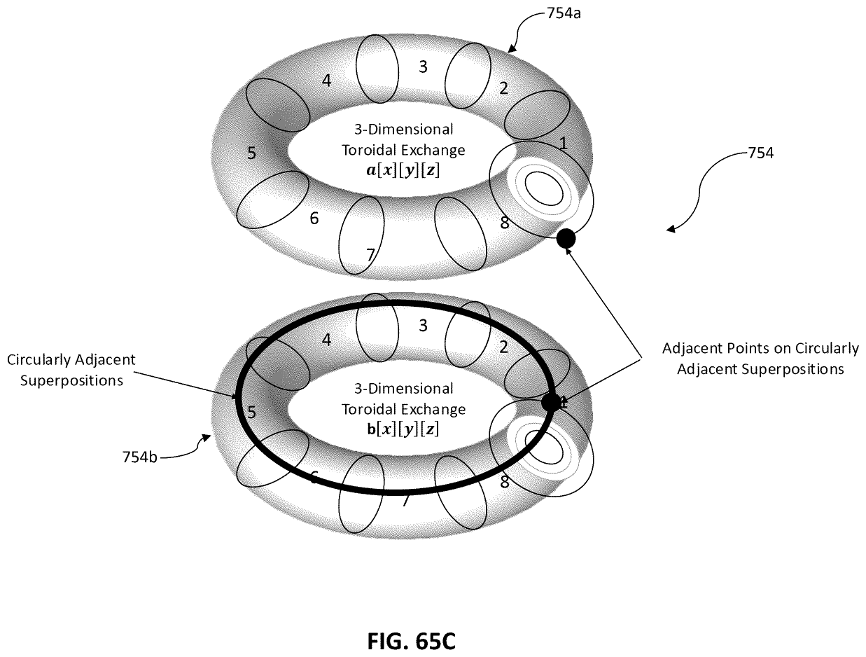

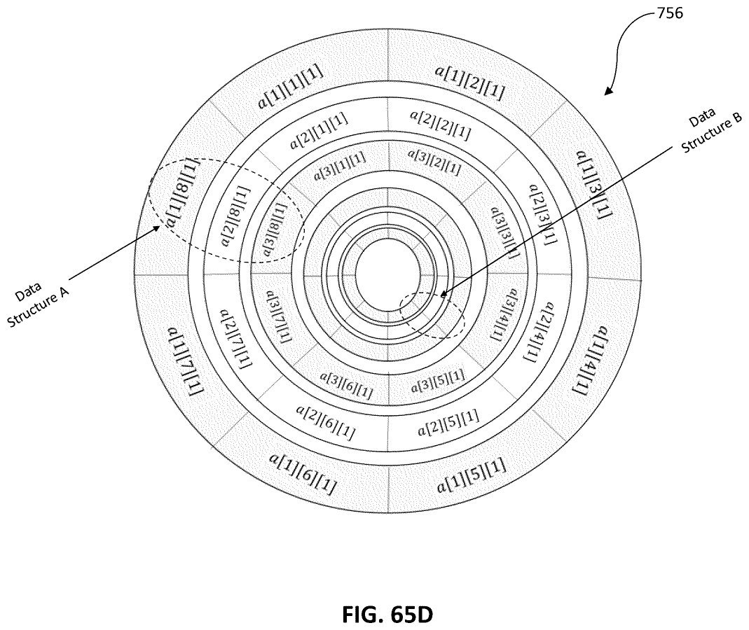

FIGS. 65A-65D provide four diagrams 750, 752, 754, 756, each showing two interacting 3-dimensional data exchanges that could take advantage of superposition. The first diagram 750 of FIG. 65A depicts two interacting 3-dimensional cylindrical data structures 750a, 750b, where each array can take advantage of superposition within itself, as shown in FIG. 64, and can share data via superposition between them along an outermost adjacent row of slices. The second diagram 752 of FIG. 65B depicts two interacting 3-dimensional toroidal data structures 752a, 752b, where each array can take advantage of superposition within itself and can share the superposition at a single array element on the outermost adjacent row of slices. The third diagram 754 of FIG. 65C depicts two interacting 3-dimensional toroidal data structures 754a, 754b, where each array can take advantage of superposition within itself and can share the superposition in a circle of array elements on the outermost adjacent row of slices. The fourth diagram 756 of FIG. 65D shows two interacting 3-dimensional data structures (either cylindrical or toroidal), where each array can take advantage of superposition within itself and can share the superposition along the entire length of the cylinder or torus by embedding one cylinder or torus within another.

These diagrams showing adjacent superposition interaction indicate superposition advantage. Entanglement is indicated when the superpositions overlap one another since one of the defining features of superposition is the existence of multiple elements simultaneously in multiple places.

FIG. 66 provides a diagram 760 showing that if there are at least two tasks that are either shared memory or shared file dependent such that one task produces (generates) or updates all or part of the shared memory or file data that is consumed (used) by another task, then care must be taken to ensure that the data consumed is the correct data, usually the most recent data available. Typically, this is accomplished by locking the memory or file until the data production or update is complete, thus serializing cross-communication. Traditionally, mutual exclusion objects (MUTEXs) are used.

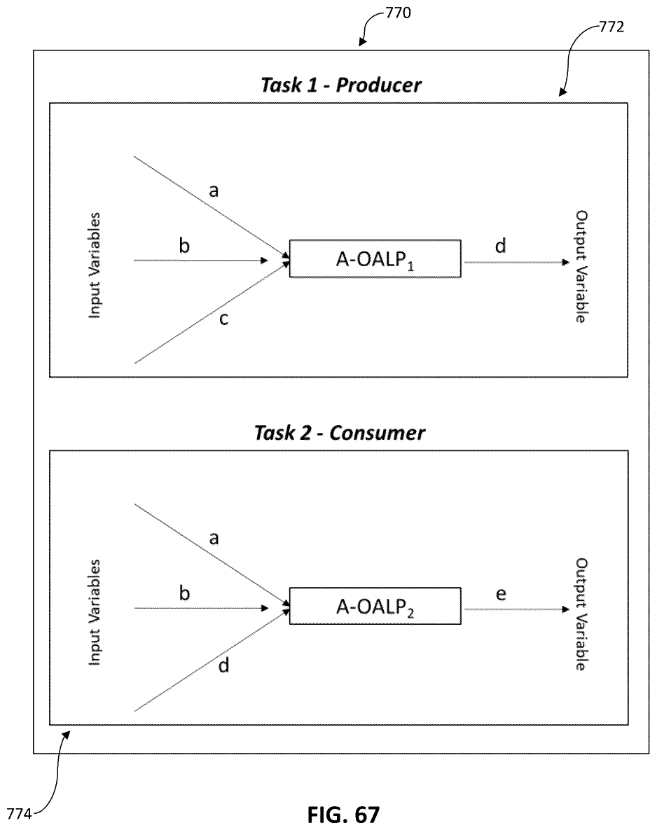

With regards to FIG. 67 through FIG. 70 (diagrams 770, 780, 790, 800), for multiple tasks that interact via the production and consumption of shared variables, it must be ensured that the production always precedes consumption. Other methods use locks as shown in FIG. 66 to manage task time order sequencing between production and consumption, forcing the serialization of cross-communication. Locks are used because of the lack of accurate and precise time prediction for the production of variables. When using advanced output affecting linear pathways (A-OALPs), each output variable produced by a computer code has an advanced time complexity automatically associated with it since an A-OALP always has a single output variable. Thus, instead of the forced serialization of cross-communication, the current art instead uses time alignment to manage time order sequencing between tasks, greatly reducing cross-communication overhead. Before A-OALP time complexity can be applied to predict the shared variable production time, the variables that are shared between tasks must be identified. This is accomplished by matching the outputs of one task, each output associated with one A-OALP, to one or more inputs of another task. Note that multiple A-OALPs per task could be involved.

FIG. 67 shows two diagrams 772, 774 of A-OALPs executing in different tasks, one per task. The first A-OALP of diagram 772 produces (generates) the value of output variable “d”. The second A-OALP of diagram 774 consumes (uses) the value of variable “d” as an input, one of three inputs shown. This shows a producer/consumer relationship between the two tasks as well as the two A-OALPs. Consider that the processing time of the first A-OALP can be predicted using its current input variable attribute values and its associated advanced time complexity (prediction analytic). Consider also that the starting times for both A-OALPs are known, either from other A-OALP-associated time prediction or from a schedule. This means that it is possible to know whether or not variable “d” has been generated prior to its use by the second A-OALP.

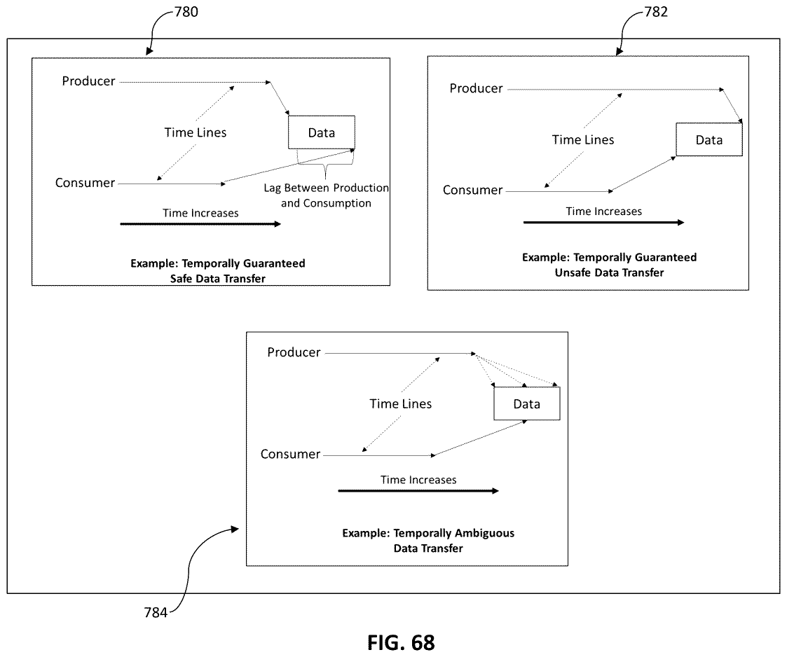

FIG. 68 provides three diagrams 780, 782, 784 showing where there is a producer and a separate consumer A-OALP. Using the producer A-OALP's predicted processing time and its starting time gives the guaranteed safe time, that is, the time when it is safe to use the produced data. The first diagram 780 shows that given the predicted start time for the producer plus its predicted processing time, the needed data will be produced before the start time of the consumer A-OALP, meaning a guaranteed temporally safe data transfer from the producer to the consumer. The second diagram 782 shows that given the predicted start time for the producer plus its predicted processing time, the needed data will not be produced before the consumer A-OALP's start time, meaning a guaranteed temporally unsafe data transfer from the producer to the consumer. The third diagram 784 shows that given the start time plus the predicted processing time of the producer, it is not clear if the needed data will be produced before the consumer A-OALP's start time, giving temporally ambiguous data transfer results. Both the guaranteed unsafe and ambiguous transfers can be converted to guaranteed safe by adjusting the starting and/or processing time of the producer or consumer. Processing time can be adjusted using dynamic loop unrolling parallelization techniques.

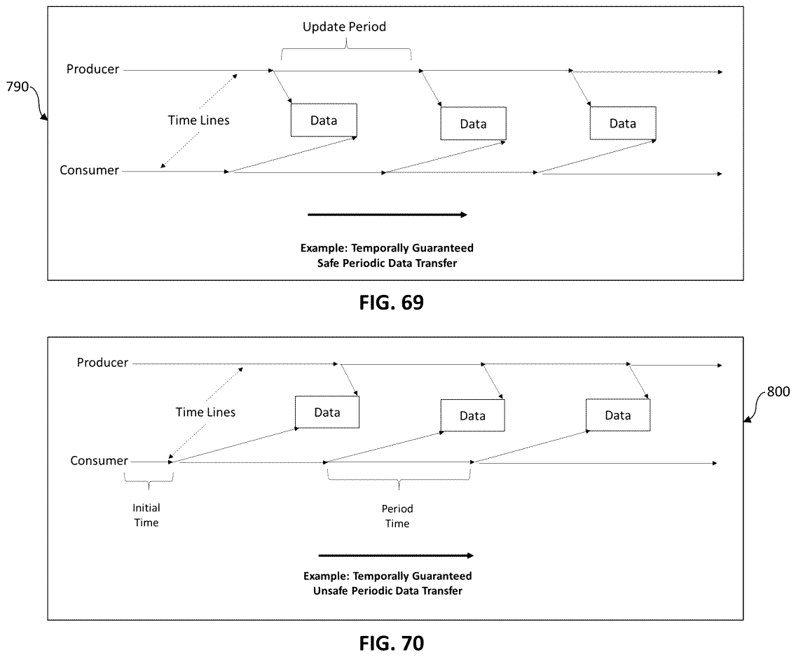

FIG. 69 shows a diagram 790 of multiple periodic data transfers. Periodic means that the producer task generates its output dataset on a fixed periodic time basis. If the consumer task uses the data generated by the producer task always after it is produced, then it is considered guaranteed safe for every periodic data transfer.

FIG. 70 also shows a diagram 800 of multiple periodic data transfers. If the consumer task uses the data generated by the producer task always before it is produced, then it is considered guaranteed unsafe for every periodic data transfer. Adjusting either the producer or consumer start or processing time can convert an always unsafe to an always safe data transfer for every period. Processing time can be adjusted using dynamic loop unrolling parallelization techniques. Note that aperiodic data transfers still require locks.

In various embodiments, a method to determine oversubscription data layouts for lockless cross-communication of A-OALPs executing on a plurality of PEs, comprises: (1) identifying one or more temporal looping structures associated with at least one input variable, (2) predicting processing time and memory allocation for the one or more temporal looping structures using advanced time complexity and advanced space complexity, (3) generating oversubscribed data elements needed for one or more boundary array elements exchanged between the plurality of PEs, (4) performing temporal reordering of exchange steps to resolve sequence order without software locks, and (5) executing the A-OALPs across the plurality of PEs using the oversubscribed data elements and the temporal reordering.

In various embodiments, the oversubscribed data elements are determined automatically based on array dimensionality.

In various embodiments, oversubscription is determined for linear data structures, oversubscription is determined for linear data structures, oversubscription is determined for cylindrical data structures, and/or oversubscription is determined for toroidal data structures.

In various embodiments, (1) left/right exchange patterns are used to determine row oversubscription, (2) up/down exchange patterns are used to determine column oversubscription, and/or (3) checkerboard, next-n-neighbor, and all-to-all exchanges are used to determine row, column, and depth oversubscription.

In various embodiments, the one or more boundary array elements are arranged in linear, circular, cylindrical, or toroidal data structures.

In various embodiments, the cylindrical or toroidal data structures enable adjacency relationships corresponding to quantum superposition.

In various embodiments, inherent quantum effects are automatically determined without using a superposition principle.

In various embodiments, oversubscription and temporal reordering rebalance workloads across the plurality of PEs.

In various embodiments, oversubscription and temporal reordering are applied to a producer task and a consumer task, and each of the producer task and the consumer task comprise an A-OALP.

In various embodiments, the method further comprises detecting adjacency in a three-dimensional cylindrical or toroidal structure to determine whether a data exchange can use quantum superposition.

In various embodiments, adjacency comprises communication between innermost and outermost slices, or adjacency comprises embedding one cylindrical or one toroidal structure within another.

In various embodiments, the detection triggers execution on a quantum processing unit.

In one or more embodiments from the perspective of computing device or system, the computing device or system includes a program code stored in memory. One or more PEs can execute the program code to: (i) identify one or more temporal looping structures associated with at least one input variable; (ii) predict processing time and memory allocation for the one or more temporal looping structures using advanced time complexity and advanced space complexity; (iii) generate oversubscribed data elements needed for one or more boundary array elements exchanged between the plurality of PEs; (iv) perform temporal reordering of exchange steps to resolve sequence order without software locks; and (v) execute the A-OALPs across the plurality of PEs using the oversubscribed data elements and the temporal reordering. Moreover, the one or more PEs can execute the program code to perform all of the described actions, steps, and methods described above, below, or otherwise herein, in whole or in part.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

It will be recognized by one skilled in the art that operations, functions, algorithms, logic, method steps, routines, sub-routines, and modules may be implemented in software, in firmware, in special purpose digital logic, and any combination thereof without deviating from the spirit and scope of the present invention as recited within the claims attached hereto.

The present invention may be embodied in other specific forms without departing from the spirit or essential attributes thereof, and it is, therefore, desired that the present embodiment be considered in all respects as illustrative and not restrictive. Similarly, the above-described methods, steps, apparatuses, and techniques for providing and using the present invention are illustrative processes and are not intended to be limited to those specifically defined herein. Further, features and aspects, in whole or in part, of the various embodiments described herein can be combined to form additional embodiments within the scope of the invention even if such combination is not specifically described herein.

While the methods, steps, and processing described above and illustrated in the drawings are shown as a sequence of steps, this was done solely for the sake of illustration. Accordingly, it is contemplated that some steps may be added, some steps may be omitted, the order of steps may be rearranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112 (f) are not to be invoked unless the specific terms “means for” or “step for” are recited in a claim.

What is claimed is:

1. A method to determine oversubscription data layouts for lockless cross-communication of Advanced Output-Affecting Linear Pathways (A-OALPs) executing on a plurality of Processing Elements (PEs), comprising:
identifying one or more temporal looping structures associated with at least one input variable;
predicting processing time and memory allocation for the one or more temporal looping structures using advanced time complexity and advanced space complexity;
generating oversubscribed data elements needed for one or more boundary array elements exchanged between the plurality of PEs;
performing temporal reordering of exchange steps to resolve sequence order without software locks; and
executing the A-OALPs across the plurality of PEs using the oversubscribed data elements and the temporal reordering.

2. The method of claim 1, wherein the oversubscribed data elements are determined automatically based on array dimensionality.

3. The method of claim 1, wherein oversubscription is determined for linear data structures, oversubscription is determined for linear data structures, oversubscription is determined for cylindrical data structures, and/or oversubscription is determined for toroidal data structures.

4. The method of claim 3, wherein:
left/right exchange patterns are used to determine row oversubscription;
up/down exchange patterns are used to determine column oversubscription; and/or
checkerboard, next-n-neighbor, and all-to-all exchanges are used to determine row, column, and depth oversubscription.

5. The method of claim 1, wherein the one or more boundary array elements are arranged in linear, circular, cylindrical, or toroidal data structures.

6. The method of claim 5, wherein the cylindrical or toroidal data structures enable adjacency relationships corresponding to quantum superposition.

7. The method of claim 1, wherein inherent quantum effects are automatically determined without using a superposition principle.

8. The method of claim 1, wherein oversubscription and temporal reordering rebalance workloads across the plurality of PEs.

9. The method of claim 1, wherein oversubscription and temporal reordering are applied to a producer task and a consumer task, and each of the producer task and the consumer task comprise an A-OALP.

10. The method of claim 1, further comprising detecting adjacency in a three-dimensional cylindrical or toroidal structure to determine whether a data exchange can use quantum superposition.

11. The method of claim 10, wherein adjacency comprises communication between innermost and outermost slices, or adjacency comprises embedding one cylindrical or one toroidal structure within another.

12. The method of claim 10, wherein the detection triggers execution on a quantum processing unit.

13. A system to determine oversubscription data layouts for lockless cross-communication of Advanced Output-Affecting Linear Pathways (A-OALPs) executing on a plurality of Processing Elements (PEs), comprising:
a memory; and
one or more processors operatively coupled with the memory, wherein the one or more processors are configured to execute program code to:
identify one or more temporal looping structures associated with at least one input variable;
predict processing time and memory allocation for the one or more temporal looping structures using advanced time complexity and advanced space complexity;
generate oversubscribed data elements needed for one or more boundary array elements exchanged between the plurality of PEs;
perform temporal reordering of exchange steps to resolve sequence order without software locks; and
execute the A-OALPs across the plurality of PEs using the oversubscribed data elements and the temporal reordering.

14. The system of claim 13, wherein the oversubscribed data elements are determined automatically based on array dimensionality.

15. The system of claim 13, wherein oversubscription is determined for linear data structures, oversubscription is determined for linear data structures, oversubscription is determined for cylindrical data structures, and/or oversubscription is determined for toroidal data structures.

16. The system of claim 15, wherein:
left/right exchange patterns are used to determine row oversubscription;
up/down exchange patterns are used to determine column oversubscription; and/or
checkerboard, next-n-neighbor, and all-to-all exchanges are used to determine row, column, and depth oversubscription.

17. The system of claim 13, wherein the one or more boundary array elements are arranged in linear, circular, cylindrical, or toroidal data structures.

18. The system of claim 17, wherein the cylindrical or toroidal data structures enable adjacency relationships corresponding to quantum superposition.

19. The system of claim 13, wherein inherent quantum effects are automatically determined without using a superposition principle.

20. The system of claim 13, wherein oversubscription and temporal reordering rebalance workloads across the plurality of PEs.

21. The system of claim 13, wherein oversubscription and temporal reordering are applied to a producer task and a consumer task, and each of the producer task and the consumer task comprise an A-OALP.

22. The system of claim 13, further comprising detecting adjacency in a three-dimensional cylindrical or toroidal structure to determine whether a data exchange can use quantum superposition, wherein, adjacency comprises communication between innermost and outermost slices, or adjacency comprises embedding one cylindrical or one toroidal structure within another.

23. The system of claim 22, wherein the detection triggers execution on a quantum processing unit.
